(19) United States
(12) Patent Application Publication
(10) Pub. No.: US 2006/0217346 A1
(43) Pub. Date: Sep. 28, 2006

(54) Fungicides

(76) Inventors: Patrick Jeff Crowley, Bracknell Bershire (GB); Roger Salmon, Bracknell, Berkshire (GB)

Correspondence Address: SYNGENTA CROP PROTECTION , INC.;PATENT AND TRADEMARK DEPARTMENT, 410 SWING ROAD, GREENSBORO, NC, 27409, US

(21) Appl. No.: 10/536,518

(22) PCT Filed: Oct. 27, 2003
(86) PCT No.: PCT/GB03/04612

§ 371 Date: May 25, 2005

(30) Foreign Application Priority Data
Nov. 26, 2002 (GB) 0227557.6

(51) Int. Cl. A01N 43/64; A01N 47/00; A01N 55/00; A01N 47/10; A01N 41/02; A01N 37/34; A01N 37/18

(52) U.S. Cl. 514/63; 514/621; 514/514; 514/517; 514/521; 514/616; 514/485; 514/383; 548/267.2; 556/413; 558/410; 556/14; 564/152

(57) ABSTRACT

The use as a plant fungicide of a compound of general formula (1). Also included are plant fungicidal compositions containing these compounds and some of the compounds themselves.

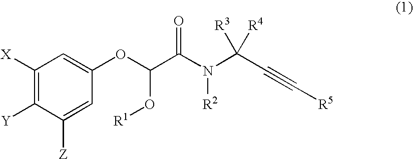

This invention relates to the use as plant fungicides of certain N-alkynyl-2-alkoxy-2-(substituted phenoxy)alkylamides. It also relates to plant fungicidal compositions containing these compounds and to some of the compounds themselves.

Certain N-alkynyl-2-(substituted phenoxy)alkylamides are described in U.S. Pat. No. 4,116,677 as being useful as herbicides. Others are described in U.S. Pat. No. 4,168,319 as being useful as mildewicides. Several N-dimethylpropynyl-α-methoxy- and α-ethoxy-α-(substituted phenoxy)acetamides are described in U.S. Pat. No. 4,062,977 for use as miticides and the compound N-dimethylpropynyl-α-methoxy-α-(3,5-dimethylphenoxy)acetamide is described in U.S. Pat. No. 4,083,867 for use as a herbicide.

The present invention is concerned with the provision of particular N-alkynyl-2-alkoxy-2-(substituted phenoxy)alkylamides for use as plant fungicides.

Thus according to the present invention there is provided the use as a plant fungicide of a compound of the general formula (1): 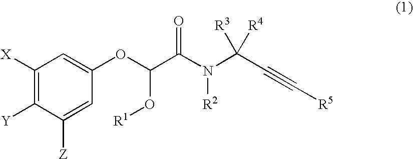
wherein
X, Y and Z are independently H, halogen, C₁₋₄ alkyl (e.g. methyl), halo(C₁₋₄)alkyl (e.g. trifluoromethyl), C₂₋₄ alkenyl, halo(C₂₋₄)alkenyl, C₂₋₄ alkynyl, halo(C₂₋₄)alkynyl, C₁₋₄ alkoxy (e.g. methoxy), halo(C₁₋₄)alkoxy (e.g. trifluoromethoxy), —S(O)ₙ(C₁₋₄)alkyl where n is 0, 1 or 2 and the alkyl group is optionally substituted with fluoro (e.g. methylthio, trifluoromethylsulphonyl), —OSO₂(C₁₋₄)alkyl where the alkyl group is optionally substituted with fluoro (e.g. trifluoromethylsulphonyloxy), cyano, nitro, C₁₋₄ alkoxycarbonyl, —CONR′R″, —COR′, —NR′COR″ or —NR′COOR′″ where R′ and R″ are independently H or C₁₋₄ alkyl and R′″ is C₁₋₄ alkyl (e.g. acetyl, —NHCOCH₃ and —NHCO₂CH₃), provided that at least one of X and Z is other than H;
R¹ is a straight-chain C₁₋₄ alkyl group (i.e. methyl, ethyl, n-propyl or n-butyl);
R² is H, C₁₋₄ alkyl, C₁₋₄ alkoxymethyl or benzyloxymethyl in which the phenyl ring of the benzyl moiety is optionally substituted with C₁₋₄ alkoxy;
R³ and R⁴ are independently H, C₁₋₃ alkyl, C₂₋₃ alkenyl or C₂₋₃ alkynyl provided that both are not H and that when both are other than H their combined total of carbon atoms does not exceed 4, or
R³ and R⁴ join with the carbon atom to which they are attached to form a 3 or 4 membered carbocyclic ring optionally containing one O, S or N atom and optionally substituted with halo or C₁₋₄ alkyl; and
R⁵ is H, C₁₋₄ alkyl or C₃₋₆ cycloalkyl in which the alkyl or cycloalkyl group is optionally substituted with halo, hydroxy, C₁₋₆ alkoxy, cyano, C₁₋₄ alkylcarbonyloxy, aminocarbonyloxy, mono- or di(C₁₋₄)alkylaminocarbonyloxy, —S(O)ₙ(C₁₋₆)alkyl where n is 0, 1 or 2, triazolyl (e.g. 1,2,4-triazol-1-yl), tri(C₁₋₄)-alkylsilyloxy, optionally substituted phenoxy, optionally substituted thienyloxy, optionally substituted benzyloxy or optionally substituted thienylmethoxy, or
R⁵ is optionally substituted phenyl, optionally substituted thienyl or optionally substituted benzyl,
in which the optionally substituted phenyl and thienyl rings of the R⁵ values are optionally substituted with one, two or three substituents selected from halo, hydroxy, mercapto, C₁₋₄ alkyl, C₂₋₄ alkenyl, C₂₋₄ alkynyl, C₁₋₄ alkoxy, C₂₋₄ alkenyloxy, C₂₋₄ alkynyloxy, halo(C₁₋₄)alkyl, halo(C₁₋₄)alkoxy, C₁₋₄ alkylthio, halo(C₁₋₄)alkylthio, hydroxy(C₁₋₄)alkyl, C₁₋₄alkoxy(C₁₋₄)alkyl, C₃₋₆ cycloalkyl, C₃₋₆ cycloalkyl(C₁₋₄)alkyl, phenoxy, benzyloxy, benzoyloxy, cyano, isocyano, thiocyanato, isothiocyanato, nitro, —NR^{m}Rⁿ, —NHCOR^{m}, —NHCONR^{m}Rⁿ, —CONR^{m}Rⁿ, —SO₂R^{m}, —OSO₂R^{m}, —COR^{m}, —CR^{m}═NRⁿ or —N═CR^{m}Rⁿ, in which R^{m} and Rⁿ are independently hydrogen, C₁₋₄ alkyl, halo(C₁₋₄)alkyl, C₁₋₄ alkoxy, halo(C₁₋₄)alkoxy, C₁₋₄ alkylthio, C₃₋₆ cycloalkyl, C₃₋₆ cycloalkyl(C₁₋₄)alkyl, phenyl or benzyl, the phenyl and benzyl groups being optionally substituted with halogen, C₁₋₄ alkyl or C₁₋₄ alkoxy.

The compounds of the invention contain at least one asymmetric carbon atom (and at least two when R³ and R⁴ are different) and may exist as enantiomers (or as pairs of diastereoisomers) or as mixtures of such. However, these mixtures may be separated into individual isomers or isomer pairs, and this invention embraces such isomers and mixtures thereof in all proportions. It is to be expected that for any given compound, one isomer may be more fungicidally active than another.

Except where otherwise stated, alkyl groups and alkyl moieties of alkoxy, alkylthio, etc., suitably contain from 1 to 4 carbon atoms in the form of straight or branched chains. Examples are methyl, ethyl, n- and iso-propyl and n-, sec-, iso- and tert-butyl. Where alkyl moieties contain 5 or 6 carbon atoms, examples are n-pentyl and n-hexyl.

Alkenyl and alkynyl moieties also suitable contain from 2 to 4 carbon atoms in the form of straight or branched chains. Examples are allyl, ethynyl and propargyl.

Halo includes fluoro, chloro, bromo and iodo. Most commonly it is fluoro, chloro or bromo and usually fluoro or chloro.

The substituents X, Y and Z on the phenyl ring of formula (1) may provide a 3-, 3,5- or 3,4,5-substituted phenyl ring. Typically X, Y and Z are all chloro or methyl, or X and Z are both chloro or bromo and Y is H or methyl, or X and Z are both methyl or methoxy and Y is H, chloro, bromo or alkylthio, or X is methoxy, Y is H and Z is cyano or chloro, or X is methyl, Y is H and Z is ethyl, or X is chloro, bromo or trifluoromethyl and both Y and Z are H.

R¹ is methyl, ethyl, n-propyl or n-butyl. Methyl and ethyl are preferred values of R¹.

Typically R² is H and at least one, but preferably both of R³ and R⁴ are methyl. When one of R³ and R⁴ is H, the other may be methyl, ethyl or n- or iso-propyl. When one of R³ and R⁴ is methyl, the other may be H or ethyl but is preferably also methyl. R² also includes C₁₋₄ alkoxymethyl and benzyloxymethyl in which the phenyl ring of the benzyl group optionally carries an alkoxy substituent, e.g. a methoxy substituent. Such values of R² provide compounds of formula (1) that are believed to be pro-pesticidal compounds.

Typically R⁵ is H, methyl, hydroxymethyl, methoxymethyl, 1-methoxyethyl, tert-butyldimethylsilyloxymethyl, 3-cyanopropyl, 3-(1,2,4-triazol-1-yl)propyl, 3-methylthiopropyl, 3-methanesulphinylpropyl or 3-methanesulphonylpropyl. Of particular interest are compounds where R⁵ is methyl, methoxymethyl or 3-cyanopropyl.

In one aspect, the invention provides the use as a plant fungicide of a compound of the general formula (1) wherein X, Y and Z are independently H, halogen, C₁₋₄ alkyl (e.g. methyl), halo(C₁₋₄)alkyl (e.g. trifluoromethyl), C₂₋₄ alkenyl, halo(C₂₋₄)alkenyl, C₂₋₄ alkynyl, halo(C₂₋₄)alkynyl, C₁₋₄ alkoxy (e.g. methoxy), halo(C₁₋₄)alkoxy (e.g. trifluoromethoxy), —S(O)ₙ(C₁₋₄)alkyl where n is 0, 1 or 2 and the alkyl group is optionally substituted with fluoro (e.g. methylthio, trifluoromethylsulphonyl), —OSO₂(C₁₋₄)alkyl where the alkyl group is optionally substituted with fluoro (e.g. trifluoromethylsulphonyloxy), cyano, nitro, C₁₋₄ alkoxycarbonyl, —CONR′R″, —COR′ or —NR′COR″ where R′ and R″ are independently H or C₁₋₄ alkyl (e.g. —NHCOCH₃), provided that at least one of X and Z is other than H;

R¹ is a straight-chain C₁₋₄ alkyl group (i.e. methyl, ethyl, n-propyl or n-butyl);

R² is H, C₁₋₄ alkyl, C₁₋₄ alkoxymethyl or benzyloxymethyl in which the phenyl ring of the benzyl moiety is optionally substituted with C₁₋₄ alkoxy,
   R³ and R⁴ are independently H, C₁₋₃ alkyl, C₂₋₃ alkenyl or C₂₋₃ alkynyl provided that both are not H and that when both are other than H their combined total of carbon atoms does not exceed 4, or
   R³ and R⁴ join with the carbon atom to which they are attached to form a 3 or 4 membered carbocyclic ring optionally containing one O, S or N atom and optionally substituted with halo or C₁₋₄ alkyl; and
   R⁵ is H, C₁₋₄ alkyl or C₃₋₆ cycloalkyl in which the alkyl or cycloalkyl group is optionally substituted with halo, hydroxy, C₁₋₆ alkoxy, C₁₋₆ alkylthio, cyano, C₁₋₄ alkylcarbonyloxy, aminocarbonyloxy or mono- or di(C₁₋₄)alkylaminocarbonyloxy, tri(C₁₋₄-alkylsilyloxy, optionally substituted phenoxy, optionally substituted thienyloxy, optionally substituted benzyloxy or optionally substituted thienylmethoxy, or
   R⁵ is optionally substituted phenyl, optionally substituted thienyl or optionally substituted benzyl,
   in which the optionally substituted phenyl and thienyl rings of the R⁵ values are optionally substituted with one, two or three substituents selected from halo, hydroxy, mercapto, C₁₋₄ alkyl, C₂₋₄ alkenyl, C₂₋₄ alkynyl, C₁₋₄ alkoxy, C₂₋₄ alkenyloxy, C₂₋₄ alkynyloxy, halo(C₁₋₄)alkyl, halo(C₁₋₄)alkoxy, C₁₋₄ alkylthio, halo(C₁₋₄)alkylthio, hydroxy(C₁₋₄)alkyl, C₁₋₄ alkoxy(C₁₋₄)alkyl, C₃₋₆ cycloalkyl, C₃₋₆ cycloalkyl(C₁₋₄)alkyl, phenoxy, benzyloxy, benzoyloxy, cyano, isocyano, thiocyanato, isothiocyanato, nitro, —NR^{m}Rⁿ, —NHCOR^{m}, —NHCONR^{m}Rⁿ, —CONR^{m}Rⁿ, —SO₂R^{m}, —OSO₂R^{m}, —COR^{m}, —CR^{m}═NRⁿ or —N═CR^{m}Rⁿ, in which R^{m} and Rⁿ are independently hydrogen, C₁₋₄ alkyl, halo(C₁₋₄)alkyl, C₁₋₄ alkoxy, halo(C₁₋₄)alkoxy, C₁₋₄ alkylthio, C₃₋₆ cycloalkyl, C₃₋₆ cycloalkyl(C₁₋₄)alkyl, phenyl or benzyl, the phenyl and benzyl groups being optionally substituted with halogen, C₁₋₄ alkyl or C₁₋₄ alkoxy.

In another aspect, the invention provides the use as a plant fungicide of a compound of the general formula (1) wherein X, Y and Z are all chloro or methyl, or X and Z are both chloro or bromo and Y is H or methyl, or X and Z are both methyl or methoxy and Y is H, chloro, bromo or alkylthio, or X is methoxy, Y is H and Z is cyano or chloro, or X is methyl, Y is H and Z is ethyl, or X is chloro, bromo or trifluoromethyl and both Y and Z are H; R¹ is methyl, ethyl, n-propyl or n-butyl; R² is H; R³ and R⁴ are both methyl; and R⁵ is H, methyl, hydroxymethyl, methoxymethyl, 1-methoxyethyl, tert-butyldimethylsilyloxymethyl, 3-cyanopropyl, 3-(1,2,4-triazol-1-yl)propyl, 3-methylthio-propyl, 3-methanesulphinylpropyl or 3-methanesulphonylpropyl. Preferably R¹ is methyl or ethyl. Preferably R⁵ is methyl, methoxymethyl or 3-cyanopropyl.

The invention also includes those compounds of the general formula (1) that are novel. Thus in another aspect the invention provides a compound of the general formula (1) wherein

X, Y and Z are independently H, halogen, C₁₋₄ alkyl (e.g. methyl), halo(C₁₋₄)alkyl (e.g. trifluoromethyl), C₂₋₄ alkenyl, halo(C₂₋₄)alkenyl, C₂₋₄ alkynyl, halo(C₂₋₄)alkynyl, C₁₋₄ alkoxy (e.g. methoxy), halo(C₁₋₄)alkoxy (e.g. trifluoromethoxy), —S(O)ₙ(C₁₋₄)alkyl where n is 0, 1 or 2 and the alkyl group is optionally substituted with fluoro (e.g. methylthio, tri-fluoromethylsulphonyl), —OSO₂(C₁₋₄)alkyl where the alkyl group is optionally substituted with fluoro (e.g. trifluoromethylsulphonyloxy), cyano, nitro, C₁₋₄ alkoxycarbonyl, —CONR′R″, —COR′, —NR′COR″ or —NR′COOR′″ where R′ and R″ are independently H or C₁₋₄ alkyl and R′″ is C₁₋₄ alkyl (e.g. acetyl, —NHCOCH₃ and —NHCO₂CH₃), provided that at least one of X and Z is other than H;

R¹ is a straight-chain C₁₋₄ alkyl group (i.e. methyl, ethyl, n-propyl or n-butyl);

R² is H, C₁₋₄ alkyl, C₁₋₄ alkoxymethyl or benzyloxymethyl in which the phenyl ring of the benzyl moiety is optionally substituted with C₁₋₄ alkoxy;

R³ and R⁴ are independently H, C₁₋₃ alkyl, C₂₋₃ alkenyl or C₂₋₃ alkynyl provided that both are not H and that when both are other than H their combined total of carbon atoms does not exceed 4, or

R³ and R⁴ join with the carbon atom to which they are attached to form a 3 or 4 membered carbocyclic ring optionally containing one O, S or N atom and optionally substituted with halo or C₁₋₄ alkyl; and

R⁵ is H, C₁₋₄ alkyl or C₃₋₆ cycloalkyl in which the alkyl or cycloalkyl group is optionally substituted with halo, hydroxy, C₁₋₆ alkoxy, cyano, C₁₋₄ alkylcarbonyloxy, aminocarbonyloxy, mono- or di(C₁₋₄)alkylaminocarbonyloxy, —S(O)ₙ(C₁₋₆)alkyl where n is 0, 1 or 2, triazolyl (e.g. 1,2,4-triazol-1-yl), tri(C₁₋₄)-alkylsilyloxy, optionally substituted phenoxy, optionally substituted thienyloxy, optionally substituted benzyloxy or optionally substituted thienylmethoxy, or

R⁵ is optionally substituted phenyl, optionally substituted thienyl or optionally substituted benzyl,

in which the optionally substituted phenyl and thienyl rings of the R⁵ values are optionally substituted with one, two or three substituents selected from halo, hydroxy, mercapto, C₁₋₄ alkyl, C₂₋₄ alkenyl, C₂₋₄ alkynyl, C₁₋₄ alkoxy, C₂₋₄ alkenyloxy, C₂₋₄ alkynyloxy, halo(C₁₋₄)alkyl, halo(C₁₋₄)alkoxy, C₁₋₄ alkylthio, halo(C₁₋₄)alkylthio, hydroxy(C₁₋₄)alkyl, C₁₋₄alkoxy(C₁₋₄)alkyl, C₃₋₆ cycloalkyl, C₃₋₆ cycloalkyl(C₁₋₄)alkyl, phenoxy, benzyloxy, benzoyloxy, cyano, isocyano, thiocyanato, isothiocyanato, nitro, —NR^{m}Rⁿ, —NHCOR^{m}, —NHCONR^{m}Rⁿ, —CONR^{m}Rⁿ, —SO₂R^{m}, —OSO₂R^{m}, —COR^{m}, —CR^{m}═NRⁿ or —N═CR^{m}Rⁿ, in which R^{m} and Rⁿ are independently hydrogen, C₁₋₄ alkyl, halo(C₁₋₄)alkyl, C₁₋₄ alkoxy, halo(C₁₋₄)alkoxy, C₁₋₄ alkylthio, C₃₋₆ cycloalkyl, C₃₋₆ cycloalkyl(C₁₋₄)alkyl, phenyl or benzyl, the phenyl and benzyl groups being optionally substituted with halogen, C₁₋₄ alkyl or C₁₋₄ alkoxy;

provided that R⁵ is not H when (i) X, Z, R¹, R³ and R⁴ are all methyl and Y, and R² are both H, (ii) X, Z, R³ and R⁴ are all methyl, Y is chloro, R¹ is ethyl and R² is H, (iii) X and Z are both chloro, R¹ is methyl or ethyl, R³ and R⁴ are both methyl and Y and R² are both H, (iv) X, Y and Z are all chloro, R¹, R³ and R⁴ are all methyl and R² is H, and (v) Y is chloro, Z is trifluoromethyl, R¹, R³ and R⁴ are all methyl and X and R² are both H.

In yet another aspect the invention provides a compound of the general formula (1) wherein

X, Y and Z are independently H, fluoro, bromo, iodo, C₂₋₄ alkyl (e.g. ethyl), halo(C₁₋₄)-alkyl (e.g. trifluoromethyl), C₂₋₄ alkenyl, halo(C₂₋₄)alkenyl, C₂₋₄ alkynyl, halo(C₂₋₄)-alkynyl, C₁₋₄ alkoxy (e.g. methoxy), halo(C₁₋₄)alkoxy (e.g. trifluoromethoxy), —S(O)ₙ—(C₁₋₄)alkyl where n is 0, 1 or 2 and the alkyl group is optionally substituted with fluoro (e.g. methylthio, trifluoromethylsulphonyl), —OSO₂(C₁₋₄)alkyl where the alkyl group is optionally substituted with fluoro (e.g. trifluoromethylsulphonyloxy), cyano, nitro, C₁₋₄ alkoxycarbonyl, —CONR′R″, —COR′, —NR′COR″ or —NR′COOR′″ where R′ and R″ are independently H or C₁₋₄ alkyl and R′″ is C₁₋₄ alkyl (e.g. acetyl, —NHCOCH₃ and —NHCO₂CH₃), provided that at least one of X and Z is other than H;

R¹ is a straight-chain C₁₋₄ alkyl group (i.e. methyl, ethyl, n-propyl or n-butyl);

R² is H, C₁₋₄ alkyl, C₁₋₄ alkoxymethyl or benzyloxymethyl in which the phenyl ring of the benzyl moiety is optionally substituted with C₁₋₄ alkoxy;

R³ and R⁴ are independently H, C₁₋₃ alkyl, C₂₋₃ alkenyl or C₂₋₃ alkynyl provided that both are not H and that when both are other than H their combined total of carbon atoms does not exceed 4, or

R³ and R⁴ join with the carbon atom to which they are attached to form a 3 or 4 membered carbocyclic ring optionally containing one O, S or N atom and optionally substituted with halo or C₁₋₄ alkyl; and

R⁵ is H, C₁₋₄ alkyl or C₃₋₆ cycloalkyl in which the alkyl or cycloalkyl group is optionally substituted with halo, hydroxy, C₁₋₆ alkoxy, cyano, C₁₋₄ alkylcarbonyloxy, aminocarbonyloxy, mono- or di(C₁₋₄)alkylaminocarbonyloxy, —S(O)ₙ(C₁₋₆)alkyl where n is 0, 1 or 2, triazolyl (e.g. 1,2,4-triazol-1-yl), tri(C₁₋₄)-alkylsilyloxy, optionally substituted phenoxy, optionally substituted thienyloxy, optionally substituted benzyloxy or optionally substituted thienylmethoxy, or

R⁵ is optionally substituted phenyl, optionally substituted thienyl or optionally substituted benzyl,

in which the optionally substituted phenyl and thienyl rings of the R⁵ values are optionally substituted with one, two or three substituents selected from halo, hydroxy, mercapto, C₁₋₄ alkyl, C₂₋₄ alkenyl, C₂₋₄ alkynyl, C₁₋₄ alkoxy, C₂₋₄ alkenyloxy, C₂₋₄ alkynyloxy, halo(C₁₋₄)alkyl, halo(C₁₋₄)alkoxy, C₁₋₄ alkylthio, halo(C₁₋₄)alkylthio, hydroxy(C₁₋₄)alkyl, C₁₋₄alkoxy(C₁₋₄)alkyl, C₃₋₆ cycloalkyl, C₃₋₆ cycloalkyl(C₁₋₄)alkyl, phenoxy, benzyloxy, benzoyloxy, cyano, isocyano, thiocyanato, isothiocyanato, nitro, —NR^{m}Rⁿ, —NHCOR^{m}, —NHCONR^{m}Rⁿ, —CONR^{m}Rⁿ, —SO₂R^{m}, —OSO₂R^{m}, —COR^{m}, —CR^{m}═NRⁿ or —N═CR^{m}Rⁿ, in which R^{m} and Rⁿ are independently hydrogen, C₁₋₄ alkyl, halo(C₁₋₄)alkyl, C₁₋₄ alkoxy, halo(C₁₋₄)alkoxy, C₁₋₄ alkylthio, C₃₋₆ cycloalkyl, C₃₋₆ cycloalkyl(C₁₋₄)alkyl, phenyl or benzyl, the phenyl and benzyl groups being optionally substituted with halogen, C₁₋₄ alkyl or C₁₋₄ alkoxy.

In yet another aspect the invention provides a compound of the general formula (1) wherein

X, Y and Z are independently H, halogen, C₁₋₄ alkyl (e.g. methyl), halo(C₁₋₄)alkyl (e.g. trifluoromethyl), C₂₋₄ alkenyl, halo(C₂₋₄)alkenyl, C₂₋₄ alkynyl, halo(C₂₋₄)alkynyl, C₁₋₄ alkoxy (e.g. methoxy), halo(C₁₋₄)alkoxy (e.g. trifluoromethoxy), —S(O)ₙ(C₁₋₄)alkyl where n is 0, 1 or 2 and the alkyl group is optionally substituted with fluoro (e.g. methylthio, trifluoromethylsulphonyl), —OSO₂(C₁₋₄)alkyl where the alkyl group is optionally substituted with fluoro (e.g. trifluoromethylsulphonyloxy), cyano, nitro, C₁₋₄ alkoxycarbonyl, —CONR′R″, —COR′, —NR′COR″ or —NR′COOR′″ where R′ and R″ are independently H or C₁₋₄ alkyl and R′″ is C₁₋₄ alkyl (e.g. acetyl, —NHCOCH₃ and —NHCO₂CH₃), provided that at least one of X and Z is other than H;

R¹ is a straight-chain C₁₋₄ alkyl group (i.e. methyl, ethyl, n-propyl or n-butyl);

R² is H, C₁₋₄ alkyl, C₁₋₄ alkoxymethyl or benzyloxymethyl in which the phenyl ring of the benzyl moiety is optionally substituted with C₁₋₄ alkoxy;

R³ and R⁴ are independently H, C₁₋₃ alkyl, C₂₋₃ alkenyl or C₂₋₃ alkynyl provided that both are not H and that when both are other than H their combined total of carbon atoms does not exceed 4, or

R³ and R⁴ join with the carbon atom to which they are attached to form a 3 or 4 membered carbocyclic ring optionally containing one O, S or N atom and optionally substituted with halo or C₁₋₄ alkyl; and

R⁵ is C₁₋₄ alkyl or C₃₋₆ cycloalkyl in which the alkyl or cycloalkyl group is optionally substituted with halo, hydroxy, C₁₋₆ alkoxy, cyano, C₁₋₄ alkylcarbonyloxy, aminocarbonyloxy, mono- or di(C₁₋₄)alkylaminocarbonyloxy, —S(O)ₙ(C₁₋₆)alkyl where n is 0, 1 or 2, triazolyl (e.g. 1,2,4-triazol-1-yl), tri(C₁₋₄)-alkylsilyloxy, optionally substituted phenoxy, optionally substituted thienyloxy, optionally substituted benzyloxy or optionally substituted thienylmethoxy, or

R⁵ is optionally substituted phenyl, optionally substituted thienyl or optionally substituted benzyl,

in which the optionally substituted phenyl and thienyl rings of the R⁵ values are optionally substituted with one, two or three substituents selected from halo, hydroxy, mercapto, C₁₋₄ alkyl, C₂₋₄ alkenyl, C₂₋₄ alkynyl, C₁₋₄ alkoxy, C₂₋₄ alkenyloxy, C₂₋₄ alkynyloxy, halo(C₁₋₄)alkyl, halo(C₁₋₄)alkoxy, C₁₋₄ alkylthio, halo(C₁₋₄)alkylthio, hydroxy(C₁₋₄)alkyl, C₁₋₄ alkoxy(C₁₋₄)alkyl, C₃₋₆ cycloalkyl, C₃₋₆ cycloalkyl(C₁₋₄)alkyl, phenoxy, benzyloxy, benzoyloxy, cyano, isocyano, thiocyanato, isothiocyanato, nitro, —NR^{m}Rⁿ, —NHCOR^{m}, —NHCONR^{m}Rⁿ, —CONR^{m}Rⁿ, —SO₂R^{m}, —OSO₂R^{m}, —COR^{m}, —CR^{m}═NRⁿ or —N═CR^{m}Rⁿ, in which R^{m} and Rⁿ are independently hydrogen, C₁₋₄ alkyl, halo(C₁₋₄)alkyl, C₁₋₄ alkoxy, halo(C₁₋₄)alkoxy, C₁₋₄ alkylthio, C₃₋₆ cycloalkyl, C₃₋₆ cycloalkyl(C₁₋₄)alkyl, phenyl or benzyl, the phenyl and benzyl groups being optionally substituted with halogen, C₁₋₄ alkyl or C₁₋₄ alkoxy.

In yet another aspect the invention provides a compound of the general formula (1) wherein

X, Y and Z are independently H, halogen, C₁₋₄ alkyl (e.g. methyl), halo(C₁₋₄)alkyl (e.g. trifluoromethyl), C₂₋₄ alkenyl, halo(C₂₋₄)alkenyl, C₂₋₄ alkynyl, halo(C₂₋₄)alkynyl, C₁₋₄ alkoxy (e.g. methoxy), halo(C₁₋₄)alkoxy (e.g. trifluoromethoxy), —S(O)ₙ(C₁₋₄)alkyl where n is 0, 1 or 2 and the alkyl group is optionally substituted with fluoro (e.g. methylthio, trifluoromethylsulphonyl), —OSO₂(C₁₋₄)alkyl where the alkyl group is optionally substituted with fluoro (e.g. trifluoromethylsulphonyloxy), cyano, nitro, C₁₋₄ alkoxy-carbonyl, —CONR′R″, —COR′ or —NR′COR″ where R′ and R″ are independently H or C₁₋₄ alkyl (e.g. —NHCOCH₃), provided that at least one of X and Z is other than H;

R¹ is a straight-chain C₁₋₄ alkyl group (e.g. methyl, ethyl, n-propyl or n-butyl);

R² is H, C₁₋₄ alkyl, C₁₋₄ alkoxymethyl or benzyloxymethyl in which the phenyl ring of the benzyl moiety is optionally substituted with C₁₋₄ alkoxy;

R³ and R⁴ are independently H, C₁₋₃ alkyl, C₂₋₃ alkenyl or C₂₋₃ alkynyl provided that both are not H and that when both are other than H their combined total of carbon atoms does not exceed 4, or

R³ and R⁴ join with the carbon atom to which they are attached to form a 3 or 4 membered carbocyclic ring optionally containing one O, S or N atom and optionally substituted with halo or C₁₋₄ alkyl; and

R⁵ is H, C₁₋₄ alkyl or C₃₋₆ cycloalkyl in which the alkyl or cycloalkyl group is optionally substituted with halo, hydroxy, C₁₋₆ alkoxy, C₁₋₆ alkylthio, cyano, C₁₋₄ alkylcarbonyloxy, aminocarbonyloxy or mono- or di(C₁₋₄)alkylaminocarbonyloxy, tri(C₁₋₄)alkylsilyloxy, optionally substituted phenoxy, optionally substituted thienyloxy, optionally substituted benzyloxy or optionally substituted thienylmethoxy, or

R⁵ is optionally substituted phenyl, optionally substituted thienyl or optionally substituted benzyl,

in which the optionally substituted phenyl and thienyl rings of the R⁵ values are optionally substituted with one, two or three substituents selected from halo, hydroxy, mercapto, C₁₋₄ alkyl, C₂₋₄ alkenyl, C₂₋₄ alkynyl, C₁₋₄ alkoxy, C₂₋₄ alkenyloxy, C₂₋₄ alkynyloxy, halo(C₁₋₄)alkyl, halo(C₁₋₄)alkoxy, C₁₋₄alkylthio, halo(C₁₋₄)alkylthio, hydroxy(C₁₋₄)alkyl, C₁₋₄ alkoxy(C₁₋₄)alkyl, C₃₋₆ cycloalkyl, C₃₋₆ cycloalkyl(C₁₋₄)alkyl, phenoxy, benzyloxy, benzoyloxy, cyano, isocyano, thiocyanato, isothiocyanato, nitro, —NR^{m}Rⁿ, —NHCOR^{m}, —NHCONR^{m}Rⁿ, —CONR^{m}Rⁿ, —SO₂R^{m}, —OSO₂R^{m}, —COR^{m}, —CR^{m}═NRⁿ or —N═CR^{m}Rⁿ, in which R^{m} and Rⁿ are independently hydrogen, C₁₋₄ alkyl, halo(C₁₋₄)alkyl, C₁₋₄ alkoxy, halo(C₁₋₄)alkoxy, C₁₋₄ alkylthio, C₃₋₆ cycloalkyl, C₃₋₆ cycloalkyl(C₁₋₄)alkyl, phenyl or benzyl, the phenyl and benzyl groups being optionally substituted with halogen, C₁₋₄ alkyl or C₁₋₄ alkoxy;

provided that R⁵ is not H when (i) X, Z, R¹, R³ and R⁴ are all methyl and Y, and R² are both H, (ii) X, Z, R³ and R⁴ are all methyl, Y is chloro, R¹ is ethyl and R² is H, (iii) X and Z are both chloro, R¹ is methyl or ethyl, R³ and R⁴ are both methyl and Y and R² are both H, (iv) X, Y and Z are all chloro, R¹, R³ and R⁴ are all methyl and R² is H, and (v) Y is chloro, Z is trifluoromethyl, R¹, R³ and R⁴ are all methyl and X and R² are both H.

In yet another aspect the invention provides a compound of the general formula (1) wherein

X, Y and Z are independently H, fluoro, bromo, iodo, C₂₋₄ alkyl (e.g. ethyl), halo(C₁₋₄)-alkyl (e.g. trifluoromethyl), C₂₋₄ alkenyl, halo(C₂₋₄)alkenyl, C₂₋₄ alkynyl, halo(C₂₋₄)-alkyl, C₁₋₄ alkoxy (e.g. methoxy), halo(C₁₋₄)alkoxy (e.g. trifluoromethoxy), —S(O)ₙ—(C₁₋₄)alkyl where n is 0, 1 or 2 and the alkyl group is optionally substituted with fluoro (e.g. methylthio, trifluoromethylsulphonyl), —OSO₂(C₁₋₄)alkyl where the alkyl group is optionally substituted with fluoro (e.g. trifluoromethylsulphonyloxy), cyano, nitro, C₁₋₄ alkoxycarbonyl, —CONR′R″, —COR′ or —NR′COR″ where R′ and R″ are independently H or C₁₋₄ alkyl (e.g. —NHCOCH₃), provided that at least one of X and Z is other than H;

R¹ is a straight-chain C₁₋₄ alkyl group (e.g. methyl, ethyl, n-propyl or n-butyl);

R² is H, C₁₋₄ alkyl, C₁₋₄ alkoxymethyl or benzyloxymethyl in which the phenyl ring of the benzyl moiety is optionally substituted with C₁₋₄ alkoxy;

R³ and R⁴ are independently H, C₁₋₃ alkyl, C₂₋₃ alkenyl or C₂₋₃ alkynyl provided that both are not H and that when both are other than H their combined total of carbon atoms does not exceed 4, or

R³ and R⁴ join with the carbon atom to which they are attached to form a 3 or 4 membered carbocyclic ring optionally containing one O, S or N atom and optionally substituted with halo or C₁₋₄ alkyl; and

R⁵ is H, C₁₋₄ alkyl or C₃₋₆ cycloalkyl in which the alkyl or cycloalkyl group is optionally substituted with halo, hydroxy, C₁₋₆ alkoxy, C₁₋₆ alkylthio, cyano, C₁₋₄ alkylcarbonyloxy, aminocarbonyloxy or mono- or di(C₁₋₄)alkylaminocarbonyloxy, tri(C₁₋₄)alkylsilyloxy, optionally substituted phenoxy, optionally substituted thienyloxy, optionally substituted benzyloxy or optionally substituted thienylmethoxy, or

R⁵ is optionally substituted phenyl, optionally substituted thienyl or optionally substituted benzyl,

in which the optionally substituted phenyl and thienyl rings of the R⁵ values are optionally substituted with one, two or three substituents selected from halo, hydroxy, mercapto, C₁₋₄ alkyl, C₂₋₄ alkenyl, C₂₋₄ alkynyl, C₁₋₄ alkoxy, C₂₋₄ alkenyloxy, C₂₋₄ alkynyloxy, halo(C₁₋₄)alkyl, halo(C₁₋₄)alkoxy, C₁₋₄ alkylthio, halo(C₁₋₄)alkylthio, hydroxy(C₁₋₄)alkyl, C₁₋₄ alkoxy(C₁₋₄)alkyl, C₃₋₆ cycloalkyl, C₃₋₆ cycloalkyl(C₁₋₄)alkyl, phenoxy, benzyloxy, benzoyloxy, cyano, isocyano, thiocyanato, isothiocyanato, nitro, —NR^{m}Rⁿ, —NHCOR^{m}, —NHCONR^{m}Rⁿ, —CONR^{m}Rⁿ, —SO₂R^{m}, —OSO₂R^{m}, —COR^{m}, —CR^{m}═NRⁿ or —N═CR^{m}Rⁿ, in which R^{m} and Rⁿ are independently hydrogen, C₁₋₄ alkyl, halo(C₁₋₄)alkyl, C₁₋₄ alkoxy, halo(C₁₋₄)alkoxy, C₁₋₄ alkylthio, C₃₋₆ cycloalkyl, C₃₋₆ cycloalkyl(C₁₋₄)alkyl, phenyl or benzyl, the phenyl and benzyl groups being optionally substituted with halogen, C₁₋₄ alkyl or C₁₋₄ alkoxy.

In yet another aspect the invention provides a compound of the general formula (1) wherein

X, Y and Z are independently H, halogen, C₁₋₄ alkyl (e.g. methyl), halo(C₁₋₄)alkyl (e.g. trifluoromethyl), C₂₋₄ alkenyl, halo(C₂₋₄)alkenyl, C₂₋₄ alkynyl, halo(C₂₋₄)alkynyl, C₁₋₄ alkoxy (e.g. methoxy), halo(C₁₋₄)alkoxy (e.g. trifluoromethoxy), —S(O)ₙ(C₁₋₄)alkyl where n is 0, 1 or 2 and the alkyl group is optionally substituted with fluoro (e.g. methylthio, trifluoromethylsulphonyl), —OSO₂(C₁₋₄)alkyl where the alkyl group is optionally substituted with fluoro (e.g. trifluoromethylsulphonyloxy), cyano, nitro, C₁₋₄ alkoxycarbonyl, —CONR′R″, —COR′ or —NR′COR″ where R′ and R″ are independently H or C₁₋₄ alkyl (e.g. —NHCOCH₃), provided that at least one of X and Z is other than H;

R¹ is a straight-chain C₁₋₄ alkyl group (e.g. methyl, ethyl, n-propyl or n-butyl);

R² is H, C₁₋₄ alkyl, C₁₋₄ alkoxymethyl or benzyloxymethyl in which the phenyl ring of the benzyl moiety is optionally substituted with C₁₋₄ alkoxy;

R³ and R⁴ are independently H, C₁₋₃ alkyl, C₂₋₃ alkenyl or C₂₋₃ alkynyl provided that both are not H and that when both are other than H their combined total of carbon atoms does not exceed 4, or

R³ and R⁴ join with the carbon atom to which they are attached to form a 3 or 4 membered carbocyclic ring optionally containing one O, S or N atom and optionally substituted with halo or C₁₋₄ alkyl; and

R⁵ is C₁₋₄ alkyl or C₃₋₆ cycloalkyl in which the alkyl or cycloalkyl group is optionally substituted with halo, hydroxy, C₁₋₆ alkoxy, C₁₋₆ alkylthio, cyano, C₁₋₄ alkylcarbonyloxy, aminocarbonyloxy or mono- or di(C₁₋₄)alkylaminocarbonyloxy, tri(C₁₋₄)alkylsilyloxy, optionally substituted phenoxy, optionally substituted thienyloxy, optionally substituted benzyloxy or optionally substituted thienylmethoxy, or

R⁵ is optionally substituted phenyl, optionally substituted thienyl or optionally substituted benzyl,

in which the optionally substituted phenyl and thienyl rings of the R⁵ values are optionally substituted with one, two or three substituents selected from halo, hydroxy, mercapto, C₁₋₄ alkyl, C₂₋₄ alkenyl, C₂₋₄ alkynyl, C₁₋₄ alkoxy, C₂₋₄ alkenyloxy, C₂₋₄ alkynyloxy, halo(C₁₋₄)alkyl, halo(C₁₋₄)alkoxy, C₁₋₄ alkylthio, halo(C₁₋₄)-alkylthio, hydroxy(C₁₋₄)alkyl, C₁₋₄ alkoxy(C₁₋₄)alkyl, C₃₋₆ cycloalkyl, C₃₋₆ cycloalkyl(C₁₋₄)-alkyl, phenoxy, benzyloxy, benzoyloxy, cyano, isocyano, thiocyanato, isothiocyanato, nitro, —NR^{m}Rⁿ, —NHCOR^{m}, —NHCONR^{m}Rⁿ, —CONR^{m}Rⁿ, —SO₂R^{m}, —OSO₂R^{m}, —COR^{m}, —CR^{m}═NRⁿ or —N═CR^{m}Rⁿ, in which R^{m} and Rⁿ are independently hydrogen, C₁₋₄ alkyl, halo(C₁₋₄)alkyl, C₁₋₄ alkoxy, halo(C₁₋₄)alkoxy, C₁₋₄ alkylthio, C₃₋₆ cycloalkyl, C₃₋₆ cycloalkyl(C₁₋₄)alkyl, phenyl or benzyl, the phenyl and benzyl groups being optionally substituted with halogen, C₁₋₄ alkyl or C₁₋₄ alkoxy.

In still yet another aspect, the invention provides a compound of the general formula (1) wherein X, Y and Z are all chloro or methyl, or X and Z are both chloro or bromo and Y is H or methyl, or X and Z are both methyl or methoxy and Y is H, chloro, bromo or alkylthio, or X is methoxy, Y is H and Z is cyano or chloro, or X is methyl, Y is H and Z is ethyl, or X is chloro, bromo or trifluoromethyl and both Y and Z are H; R¹ is methyl, ethyl, n-propyl or n-butyl; R² is H; R³ and R⁴ are both methyl; and R⁵ is methyl, hydroxymethyl, methoxymethyl, 1-methoxyethyl, tert-butyldimethylsilyloxymethyl, 3-cyanopropyl, 3-(1,2,4-triazol-1-yl)propyl, 3-methylthiopropyl, 3-methanesulphinylpropyl or 3-methanesulphonylpropyl. Preferably R¹ is methyl or ethyl. Preferably R⁵ is methyl, methoxymethyl or 3-cyanopropyl

Compounds that form part of the invention are illustrated in Tables 1 to 26 below.

The compounds in Table 1 are of the general formula (1) where R₁ is ethyl, R² is H, R³ and R⁴ are both methyl, R⁵ is methyl and X, Y and Z have the values given in the table.

TABLE 1

| Compound No | X | Y | Z |
|---|---|---|---|
| 1 | Cl | Cl | CN |
| 2 | Cl | Cl | Cl |
| 3 | CH₃ | CH₃ | CH₃ |
| 4 | Cl | H | Cl |
| 5 | Cl | CH₃ | Cl |
| 6 | Br | H | Br |
| 7 | Br | CH₃ | Br |
| 8 | CH₃ | H | CH₃ |
| 9 | CH₃ | Cl | CH₃ |
| 10 | CH₃ | Br | CH₃ |
| 11 | CH₃ | CH₃S | CH₃ |
| 12 | CH₃O | H | CH₃O |
| 13 | CH₃O | Cl | CH₃O |
| 14 | CH₃O | Br | CH₃O |
| 15 | CH₃O | CH₃S | CH₃O |
| 16 | CH₃O | H | CN |
| 17 | CH₃O | H | Cl |
| 18 | CH₃ | H | C₂H₅ |
| 19 | Cl | H | H |
| 20 | Br | H | H |
| 21 | CF₃ | H | H |
| 22 | Br | Cl | H |
| 23 | Br | Br | H |
| 24 | Br | F | H |
| 25 | Br | CN | H |
| 26 | Br | CF₃O | H |
| 27 | Br | CH₃S | H |
| 28 | Br | HC≡C— | H |
| 29 | Br | CH₂═CH— | H |
| 30 | H | CH₃O | H |
| 31 | Br | COCH₃ | H |
| 32 | Br | CF₃ | H |
| 33 | F | H | H |
| 34 | CN | H | H |
| 35 | CH₃ | H | H |
| 36 | CH₃CO | H | H |
| 37 | CH₃O | H | H |
| 38 | CF₃O | H | H |
| 39 | CH₃S | H | H |
| 40 | HC≡C— | H | H |
| 41 | H₂C═CH— | H | H |
| 42 | F | H | F |
| 43 | F | H | Cl |
| 44 | F | H | Br |
| 45 | F | H | CH₃O |
| 46 | F | H | CH₃CO |
| 47 | F | H | CN |
| 48 | F | H | CH₃ |
| 49 | F | H | CF₃O |
| 50 | F | H | CF₃ |
| 51 | F | H | CH₃S |
| 52 | F | H | COOCH₃ |
| 53 | Cl | H | Br |
| 54 | Cl | H | CH₃CO |
| 55 | Cl | H | CH₃ |
| 56 | Cl | H | CN |
| 57 | Cl | H | CF₃O |
| 58 | Cl | H | CF₃ |
| 59 | Cl | H | CH₃S |
| 60 | Cl | H | COOCH₃ |
| 61 | Cl | H | CON(CH₃)₂ |
| 62 | Cl | H | NHCOOCH₃ |
| 63 | Cl | H | OSO₂CH₃ |
| 64 | Cl | H | HC≡C— |
| 65 | Cl | H | CH₂═CH— |
| 66 | Br | H | CH₃ |
| 67 | Br | H | CN |
| 68 | CN | H | CN |
| 69 | CN | H | CH₃ |
| 70 | CN | H | CF₃O |
| 71 | CF₃O | H | CF₃O |
| 72 | CF₃ | H | CF₃ |
| 73 | CH₃ | H | CH₃O |
| 74 | F | F | H |
| 75 | F | Cl | H |
| 76 | F | Br | H |
| 77 | F | CH₃O | H |
| 78 | F | CN | H |
| 79 | F | CH₃ | H |
| 80 | Cl | Cl | H |
| 81 | Cl | F | H |
| 82 | Cl | Br | H |
| 83 | Cl | CN | H |
| 84 | Cl | CH₃ | H |
| 85 | Cl | CH₃O | H |
| 86 | Cl | CF₃O | H |
| 87 | Cl | CH₃S | H |
| 88 | Cl | CH₃SO₂O | H |
| 89 | Cl | CH₃CO | H |
| 90 | CN | F | H |
| 91 | CN | Cl | H |
| 92 | CN | CH₃O | H |
| 93 | CH₃O | CH₃O | H |
| 94 | CH₃O | Cl | H |
| 95 | CH₃O | CN | H |
| 96 | CH₃CO | Cl | H |
| 97 | CF₃O | Cl | H |
| 98 | CF₃O | CN | H |
| 99 | CH₃S | Cl | H |
| 100 | CH₃S | F | H |
| 101 | CH₃S | CH₃ | H |
| 102 | CH₃SO₂O | Cl | H |
| 103 | Cl | Cl | F |
| 104 | Cl | Cl | Br |
| 105 | Cl | Cl | CH₃O |
| 106 | Cl | Cl | CH₃CO |
| 107 | Cl | Cl | CH₃S |
| 108 | Cl | F | Cl |
| 109 | Cl | CH₃O | Cl |
| 110 | Cl | CF₃O | Cl |
| 111 | Cl | CH₃SO | Cl |
| 112 | Cl | CH₃SO₂ | Cl |
| 113 | Cl | OSO₂CH₃ | Cl |
| 114 | Cl | CH₃CO | Cl |
| 115 | Cl | CO₂CH₃ | Cl |
| 116 | Cl | CON(CH₃)₂ | Cl |
| 117 | Cl | HC≡C— | Cl |
| 118 | Cl | CH₂═CH— | Cl |
| 119 | Cl | NHCO₂CH₃ | Cl |
| 120 | F | F | F |
| 121 | F | F | CN |
| 122 | F | F | CH₃ |
| 123 | F | F | CH₃O |
| 124 | F | CH₃O | F |
| 125 | F | CF₃O | F |
| 126 | F | CH₃SO | F |
| 127 | F | CH₃SO₂ | F |
| 128 | F | OSO₂CH₃ | F |
| 129 | F | CH₃CO | F |
| 130 | F | CO₂CH₃ | F |
| 131 | CH₃O | CH₃O | CH₃O |
| 132 | CH₃O | CH₃O | Cl |
| 133 | CH₃O | CH₃O | CH₃ |
| 134 | Cl | CN | Cl |

Table 2

Table 2 consists of 134 compounds of the general formula (1), where R¹ is methyl, R² is hydrogen, R³ and R⁴ are both methyl, R⁵ is methyl and X, Y and Z have the values listed in Table 1. Thus compound 1 of Table 2 is the same as compound 1 of Table 1 except that in compound 1 of Table 2 R¹ is methyl instead of ethyl. Similarly, compounds 2 to 134 of Table 2 are the same as compounds 2 to 134 of Table 1, respectively, except that in the compounds of Table 2 R¹ is methyl instead of ethyl.

Table 3

Table 3 consists of 134 compounds of the general formula (1), where R¹ is n-propyl, R² is hydrogen, R³ and R⁴ are both methyl, and R⁵ is methyl and X, Y and Z have the values listed in Table 1. Thus compound 1 of Table 3 is the same as compound 1 of Table 1 except that in compound 1 of Table 3 R¹ is n-propyl instead of ethyl. Similarly, compounds 2 to 134 of Table 3 are the same as compounds 2 to 134 of Table 1, respectively, except that in the compounds of Table 3 R¹ is n-propyl instead of ethyl.

Table 4

Table 4 consists of 134 compounds of the general formula (1), where R¹ is n-butyl, R² is hydrogen, R³ and R⁴ are both methyl, R⁵ is methyl and X, Y and Z have the values listed in Table 1. Thus compound 1 of Table 4 is the same as compound 1 of Table 1 except that in compound 1 of Table 4 R¹ is n-butyl instead of ethyl. Similarly, compounds 2 to 134 of Table 4 are the same as compounds 2 to 134 of Table 1, respectively, except that in the compounds of Table 4 R¹ is n-butyl instead of ethyl.

Table 5

Table 5 consists of 134 compounds of the general formula (1), where R¹ is ethyl, R² is hydrogen, R³ and R⁴ are both methyl, R⁵ is H and X, Y and Z have the values listed in Table 1. Thus compound 1 of Table 5 is the same as compound 1 of Table 1 except that in compound 1 of Table 5 R⁵ is H instead of methyl. Similarly, compounds 2 to 134 of Table 5 are the same as compounds 2 to 134 of Table 1, respectively, except that in the compounds of Table 5 R⁵ is H instead of methyl.

Table 6

Table 6 consists of 134 compounds of the general formula (1), where R¹ is methyl, R² is hydrogen, R³ and R⁴ are both methyl, R⁵ is H and X, Y and Z have the values listed in Table 1. Thus compound 1 of Table 6 is the same as compound 1 of Table 2 except that in compound 1 of Table 6 R⁵ is H instead of methyl. Similarly, compounds 2 to 134 of Table 6 are the same as compounds 2 to 134 of Table 2, respectively, except that in the compounds of Table 6 R⁵ is H instead of methyl.

Table 7

Table 7 consists of 134 compounds of the general formula (1), where R¹ is n-propyl, R² is hydrogen, R³ and R⁴ are both methyl, and R⁵ is H and X, Y and Z have the values listed in Table 1. Thus compound 1 of Table 7 is the same as compound 1 of Table 3 except that in compound 1 of Table 7 R⁵ is H instead of methyl. Similarly, compounds 2 to 134 of Table 7 are the same as compounds 2 to 134 of Table 3, respectively, except that in the compounds of Table 7 R⁵ is H instead of methyl.

Table 8

Table 8 consists of 134 compounds of the general formula (1), where R¹ is n-butyl, R² is hydrogen, R³ and R⁴ are both methyl, R⁵ is H and X, Y and Z have the values listed in Table 1. Thus compound 1 of Table 8 is the same as compound 1 of Table 4 except that in compound 1 of Table 8 R⁵ is H instead of methyl. Similarly, compounds 2 to 134 of Table 8 are the same as compounds 2 to 134 of Table 4, respectively, except that in the compounds of Table 8 R⁵ is H instead of methyl.

Table 9

Table 9 consists of 134 compounds of the general formula (1), where R¹ is ethyl, R² is hydrogen, R³ and R⁴ are both methyl, R⁵ is hydroxymethyl and X, Y and Z have the values listed in Table 1. Thus compound 1 of Table 9 is the same as compound 1 of Table 1 except that in compound 1 of Table 9 R⁵ is hydroxymethyl instead of methyl. Similarly, compounds 2 to 134 of Table 9 are the same as compounds 2 to 134 of Table 1, respectively, except that in the compounds of Table 9 R⁵ is hydroxymethyl instead of methyl.

Table 10

Table 10 consists of 134 compounds of the general formula (1), where R¹ is methyl, R² is hydrogen, R³ and R⁴ are both methyl, R⁵ is hydroxymethyl and X, Y and Z have the values listed in Table 1. Thus compound 1 of Table 10 is the same as compound 1 of Table 2 except that in compound 1 of Table 10 R⁵ is hydroxymethyl instead of methyl. Similarly, compounds 2 to 134 of Table 10 are the same as compounds 2 to 134 of Table 2, respectively, except that in the compounds of Table 10 R⁵ is hydroxymethyl instead of methyl.

Table 11

Table 11 consists of 134 compounds of the general formula (1), where R¹ is n-propyl, R² is hydrogen, R³ and R⁴ are both methyl, and R⁵ is hydroxymethyl and X, Y and Z have the values listed in Table 1. Thus compound 1 of Table 11 is the same as compound 1 of Table 3 except that in compound 1 of Table 11 R⁵ is hydroxymethyl instead of methyl. Similarly, compounds 2 to 134 of Table 11 are the same as compounds 2 to 134 of Table 3, respectively, except that in the compounds of Table 11 R⁵ is hydroxymethyl instead of methyl.

Table 12

Table 12 consists of 134 compounds of the general formula (1), where R¹ is n-butyl, R² is hydrogen, R³ and R⁴ are both methyl, R⁵ is hydroxymethyl and X, Y and Z have the values listed in Table 1. Thus compound 1 of Table 12 is the same as compound 1 of Table 4 except that in compound 1 of Table 12 R⁵ is hydroxymethyl instead of methyl. Similarly, compounds 2 to 134 of Table 12 are the same as compounds 2 to 134 of Table 4, respectively, except that in the compounds of Table 12 R⁵ is hydroxymethyl instead of methyl.

Table 13

Table 13 consists of 134 compounds of the general formula (1), where R¹ is ethyl, R² is hydrogen, R³ and R⁴ are both methyl, R⁵ is methoxymethyl and X, Y and Z have the values listed in Table 1. Thus compound 1 of Table 13 is the same as compound 1 of Table 1 except that in compound 1 of Table 13 R⁵ is methoxymethyl instead of methyl. Similarly, compounds 2 to 134 of Table 13 are the same as compounds 2 to 134 of Table 1, respectively, except that in the compounds of Table 13 R⁵ is methoxymethyl instead of methyl.

Table 14

Table 14 consists of 134 compounds of the general formula (1), where R¹ is methyl, R² is hydrogen, R³ and R⁴ are both methyl, R⁵ is methoxymethyl and X, Y and Z have the values listed in Table 1. Thus compound 1 of Table 14 is the same as compound 1 of Table 2 except that in compound 1 of Table 14 R⁵ is methoxymethyl instead of methyl. Similarly, compounds 2 to 134 of Table 14 are the same as compounds 2 to 134 of Table 2, respectively, except that in the compounds of Table 14 R⁵ is methoxymethyl instead of methyl.

Table 15

Table 15 consists of 134 compounds of the general formula (1), where R¹ is n-propyl, R² is hydrogen, R³ and R⁴ are both methyl, and R⁵ is methoxymethyl and X, Y and Z have the values listed in Table 1. Thus compound 1 of Table 15 is the same as compound 1 of Table 3 except that in compound 1 of Table 15 R⁵ is methoxymethyl instead of methyl. Similarly, compounds 2 to 134 of Table 15 are the same as compounds 2 to 134 of Table 3, respectively, except that in the compounds of Table 15 R⁵ is methoxymethyl instead of methyl.

Table 16

Table 16 consists of 134 compounds of the general formula (1), where R¹ is n-butyl, R² is hydrogen, R³ and R⁴ are both methyl, R⁵ is methoxymethyl and X, Y and Z have the values listed in Table 1. Thus compound 1 of Table 16 is the same as compound 1 of Table 4 except that in compound 1 of Table 16 R⁵ is methoxymethyl instead of methyl. Similarly, compounds 2 to 134 of Table 16 are the same as compounds 2 to 134 of Table 4, respectively, except that in the compounds of Table 16 R⁵ is methoxymethyl instead of methyl.

Table 17

Table 17 consists of 134 compounds of the general formula (1), where R¹ is ethyl, R² is hydrogen, R³ and R⁴ are both methyl, R⁵ is tert-butyldimethylsilyloxymethyl and X, Y and Z have the values listed in Table 1. Thus compound 1 of Table 17 is the same as compound 1 of Table 1 except that in compound 1 of Table 17 R⁵ is tert-butyldimethyl-silyloxymethyl instead of methyl. Similarly, compounds 2 to 134 of Table 17 are the same as compounds 2 to 134 of Table 1, respectively, except that in the compounds of Table 17 R⁵ is tert-butyldimethylsilyloxymethyl instead of methyl.

Table 18

Table 18 consists of 134 compounds of the general formula (1), where R¹ is methyl, R² is hydrogen, R³ and R⁴ are both methyl, R⁵ is tert-butyldimethylsilyloxymethyl and X, Y and Z have the values listed in Table 1. Thus compound 1 of Table 18 is the same as compound 1 of Table 2 except that in compound 1 of Table 18 R⁵ is tert-butyldimethyl-silyloxymethyl instead of methyl. Similarly, compounds 2 to 134 of Table 18 are the same as compounds 2 to 134 of Table 2, respectively, except that in the compounds of Table 18 R⁵ is tert-butyldimethylsilyloxymethyl instead of methyl.

Table 19

Table 19 consists of 134 compounds of the general formula (1), where R¹ is n-propyl, R² is hydrogen, R³ and R⁴ are both methyl, and R⁵ is tert-butyldimethylsilyloxymethyl and X, Y and Z have the values listed in Table 1. Thus compound 1 of Table 19 is the same as compound 1 of Table 3 except that in compound 1 of Table 19 R⁵ is tert-butyldimethylsilyloxymethyl instead of methyl. Similarly, compounds 2 to 134 of Table 19 are the same as compounds 2 to 134 of Table 3, respectively, except that in the compounds of Table 19 R⁵ is tert-butyldimethylsilyloxymethyl instead of methyl.

Table 20

Table 20 consists of 134 compounds of the general formula (1), where R¹ is n-butyl, R² is hydrogen, R³ and R⁴ are both methyl, R⁵ is tert-butyldimethylsilyloxymethyl and X, Y and Z have the values listed in Table 1. Thus compound 1 of Table 20 is the same as compound 1 of Table 4 except that in compound 1 of Table 20 R⁵ is tert-butyldimethylsilyloxymethyl instead of methyl. Similarly, compounds 2 to 134 of Table 20 are the same as compounds 2 to 134 of Table 4, respectively, except that in the compounds of Table 20 R⁵ is tert-butyldimethylsilyloxymethyl instead of methyl.

Table 21

Table 21 consists of 134 compounds of the general formula (1), where R¹ is ethyl, R² is hydrogen, R³ and R⁴ are both methyl, R⁵ is 1-methoxyethyl and X, Y and Z have the values listed in Table 1. Thus compound 1 of Table 21 is the same as compound 1 of Table 1 except that in compound 1 of Table 21 R⁵ is 1-methoxyethyl instead of methyl. Similarly, compounds 2 to 134 of Table 21 are the same as compounds 2 to 134 of Table 1, respectively, except that in the compounds of Table 21 R⁵ is 1-methoxyethyl instead of methyl.

Table 22

Table 22 consists of 134 compounds of the general formula (1), where R¹ is methyl, R² is hydrogen, R³ and R⁴ are both methyl, R⁵ is 1-methoxyethyl and X, Y and Z have the values listed in Table 1. Thus compound 1 of Table 22 is the same as compound 1 of Table 2 except that in compound 1 of Table 22 R⁵ is 1-methoxyethyl instead of methyl. Similarly, compounds 2 to 134 of Table 22 are the same as compounds 2 to 134 of Table 2, respectively, except that in the compounds of Table 22 R⁵ is 1-methoxyethyl instead of methyl.

Table 23

Table 23 consists of 134 compounds of the general formula (1), where R¹ is n-propyl, R² is hydrogen, R³ and R⁴ are both methyl, and R⁵ is 1-methoxyethyl and X, Y and Z have the values listed in Table 1. Thus compound 1 of Table 23 is the same as compound 1 of Table 3 except that in compound 1 of Table 23 R⁵ is 1-methoxyethyl instead of methyl. Similarly, compounds 2 to 134 of Table 23 are the same as compounds 2 to 134 of Table 3, respectively, except that in the compounds of Table 23 R⁵ is 1-methoxyethyl instead of methyl.

Table 24

Table 24 consists of 134 compounds of the general formula (1), where R¹ is n-butyl, R² is hydrogen, R³ and R⁴ are both methyl, R⁵ is 1-methoxyethyl and X, Y and Z have the values listed in Table 1. Thus compound 1 of Table 24 is the same as compound 1 of Table 4 except that in compound 1 of Table 24 R⁵ is 1-methoxyethyl instead of methyl. Similarly, compounds 2 to 134 of Table 24 are the same as compounds 2 to 134 of Table 4, respectively, except that in the compounds of Table 24 R⁵ is 1-methoxyethyl instead of methyl.

Table 25

Table 25 consists of 134 compounds of the general formula (1), where R¹ is ethyl, R² is hydrogen, R³ and R⁴ are both methyl, R⁵ is 3-cyanopropyl and X, Y and Z have the values listed in Table 1. Thus compound 1 of Table 25 is the same as compound 1 of Table 1 except that in compound 1 of Table 25 R⁵ is 3-cyanopropyl instead of methyl. Similarly, compounds 2 to 134 of Table 25 are the same as compounds 2 to 134 of Table 1, respectively, except that in the compounds of Table 25 R⁵ is 3-cyanopropyl instead of methyl.

Table 26

Table 26 consists of 134 compounds of the general formula (1), where R¹ is methyl, R² is hydrogen, R³ and R⁴ are both methyl, R⁵ is 3-cyanopropyl and X, Y and Z have the values listed in Table 1. Thus compound 1 of Table 26 is the same as compound 1 of Table 2 except that in compound 1 of Table 26 R⁵ is 3-cyanopropyl instead of methyl. Similarly, compounds 2 to 134 of Table 26 are the same as compounds 2 to 134 of Table 2, respectively, except that in the compounds of Table 26 R⁵ is 3-cyanopropyl instead of methyl.

The compounds of general formula (I) may be prepared as outlined in Schemes 1 to 3 below, in which X, Y, Z, R¹, R², R³, R⁴ and R⁵ have the meanings given above, L is a leaving group such as halo, methylsulphonyloxy or arylsulphonyloxy (e.g. phenylsulphonyloxy), R is H or C₁₋₄ alkyl, as indicated, R^{a} is H or C₁₋₃ alkyl, R^{b} is H or C₁₋₃ alkyl, provided that when R^{a} and R^{b} are both alkyl their total number of carbon atoms does not exceed 3, R^{c} is C₁₋₆alkyl, optionally substituted benzyl or optionally substituted thienylmethyl, DMF is N,N-dimethylformamide and DMAP is 4-dimethylaminopyridine. Compounds of general formula (1) may be prepared as shown in Scheme 1. Esters of formula (2), where R is C₁₋₄ alkyl, may be halogenated to give haloesters of formula (3), where Hal is a halogen atom such as chlorine or bromine, by treatment with a suitable halogenating agent, such as N-bromosuccinimide, in a suitable solvent such as carbon tetrachloride, at between room temperature and the reflux temperature of the solvent. Haloesters of formula (3) can be reacted in R¹OH as solvent in the presence of a base such as calcium or potassium carbonate, or a metal alkoxide M⁺R¹O⁻, where M can be suitably sodium or potassium, at between 0° C. and 40° C., preferably at room temperature, to give esters of formula (6). Alternatively esters of formula (6) can be formed by reaction of phenols of formula (4) and compounds of formula (5), in the presence of a base such a potassium t-butoxide, in suitable solvent such a t-butanol. The esters of formula (6) can be hydrolysed to acids of formula (7) by treatment with an alkali metal hydroxide, such as sodium hydroxide, in an aqueous alcohol ROH, at between room temperature and reflux. The acids of formula (7) can be condensed with the amines of formula (8) to give the compounds of general formula (1), using suitable activating reagents such as HOBT (1-hydroxybenztriazole) and EDC (1-ethyl-3-N,N-dimethyl-aminopropylcarbodiimide hydrochloride).

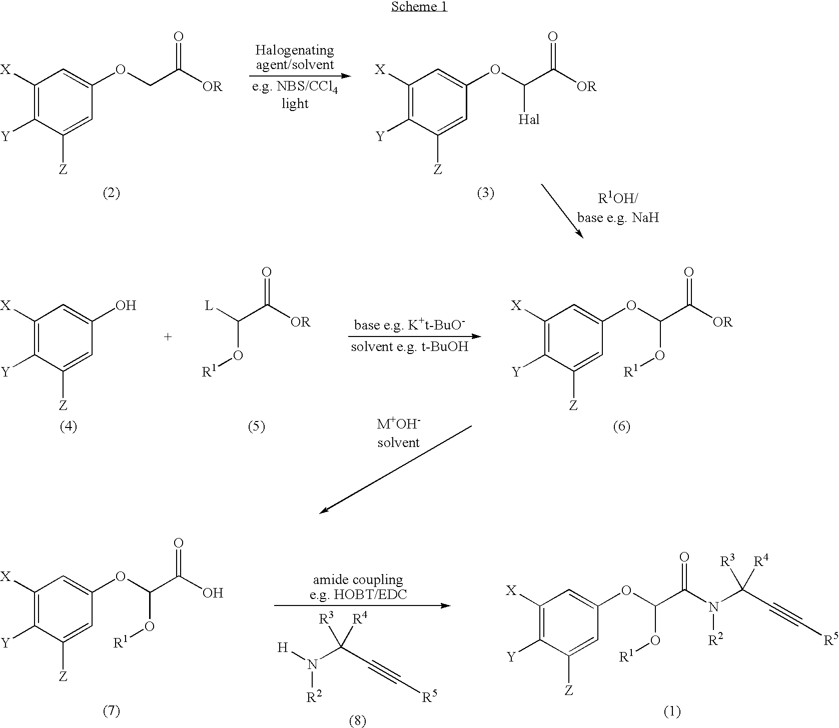

As shown in Scheme 2, amines of general formula (8), wherein R² is H, correspond to amines of general formula (12) and may be prepared by alkylation of a silyl-protected aminoalkyne of general formula (10) using a suitable base such as n-butyl lithium and reacting with a suitable alkylating reagent R⁵L, such as an alkyl iodide, for example, methyl iodide, to form an alkylated compound of general formula (11). In a similar procedure, a silyl-protected aminoalkyne of general formula (10) may be reacted with a carbonyl derivative R^{a}COR^{b}, for example formaldehyde or acetaldehyde, using a suitable base, such as n-butyl lithium, to provide an aminoalkyne (11) in which R⁵ is a hydroxyalkyl moiety. The silyl protecting group may then be removed from a compound of general formula (11) with, for example, an aqueous acid to form an aminoalkyne of general formula (12). Aminoalkynes of general formula (12) may be further derivatised, for instance when R⁵ is a hydroxyalkyl group, for example, by reacting a compound of general formula (12) with a silylating agent, for example tert-butyldimethylsilyl chloride, to give a trialkylsilyloxy derivative of general formula (13). In another method, a compound of general formula (12) may be treated with a base, such as sodium hydride or potassium bis(trimethylsilyl)amide, followed by a compound R^{c}L, where L represents a halogen or sulphonate ester such as OSO₂Me, or OSO₂-4-tolyl, to give compounds of general formula (15). In an alternative sequence, a compound of general formula (11) may be treated with a base, such as sodium or potassium bis(trimethylsilyl)amide, followed by a compound R^{c}L, where L represents a halogen or sulphonate ester such as OSO₂Me, or OSO₂-4-tolyl to give, after removal of the silyl protecting group, compounds of general formula (15).

Compounds of general formula (11), where R⁵ is for example 3-chloropropyl, can be reacted with a metal cyanide salt, such as sodium cyanide, to gives compounds of general formula (16), which can then be hydrolysed, with for example an aqueous acid, to give the amines of general formula (17). Compounds of general formula (11), where R⁵ is for example 3-chloropropyl, can be hydrolysed, with for example an aqueous acid, to give amines of general formula (18).

The R² group may be introduced into an aminoalkyne of general formula (12) by known techniques to form an amine of general formula (8), where R² is other than H. Silyl-protected aminoalkynes of general formula (10) may be obtained by reacting amines of general formula (9) with 1,2-bis-(chlorodimethylsilyl)ethane in the presence of a suitable base, such as a tertiary organic amine base, for example, triethylamine.

The amine (9) is either commercially available or may be prepared by standard literature methods (see, for example, EP-A-0834498) from commercially available materials. 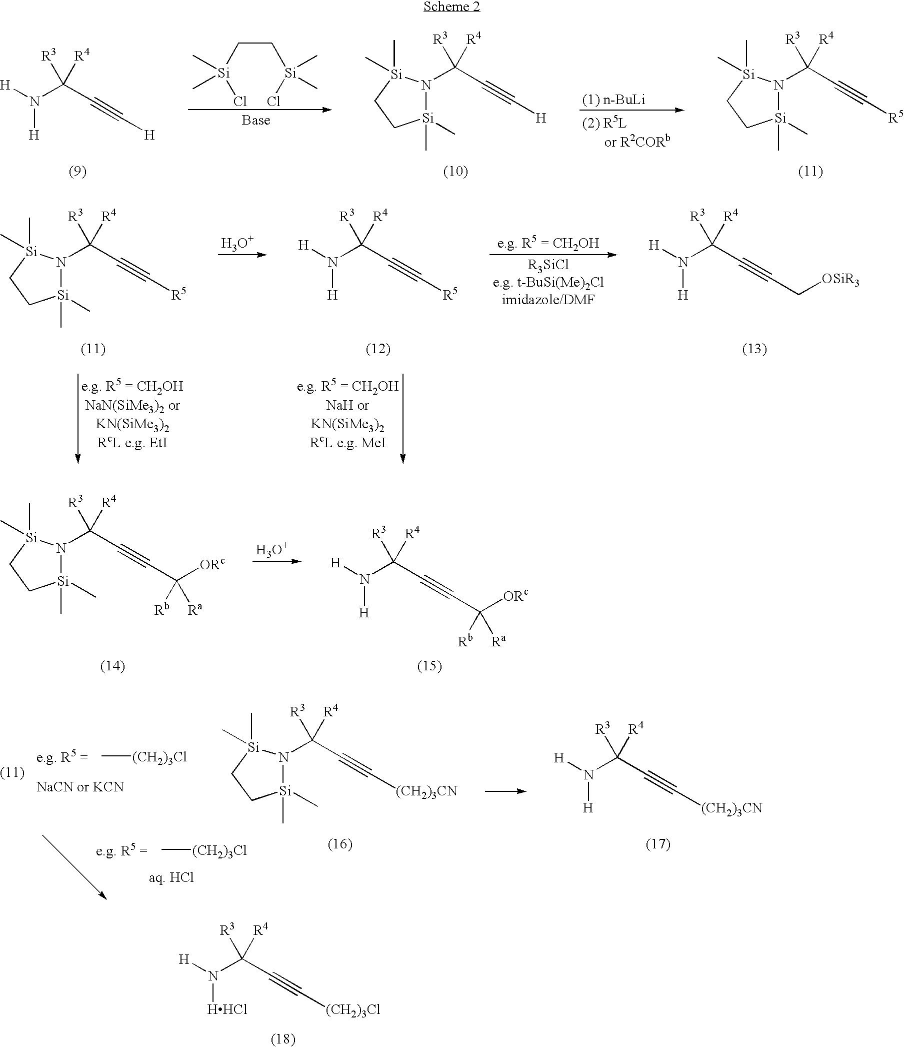
As shown in Scheme 3, compounds of general formula (1), where R⁵ is for example 3-chloropropyl can be reacted with various nucleophiles such as a metal cyanide salt, for example sodium cyanide, to give compounds of general formula (19), with metal alkoxides for example sodium methoxide, to give compounds of general formula (20), with 1,2,4-triazole in the presence of base such as triethylamine to give compounds of general formula (21), and with metal thioalkoxides, for example sodium methanethiolate to give compounds of general formula (22). Compounds of general formula (22) can be treated with oxidising agents such as sodium periodate, to give sulphoxides of general formula (23), or with oxidising agents such as m-chloroperbenzoic acid, to give sulphones of general formula (24)

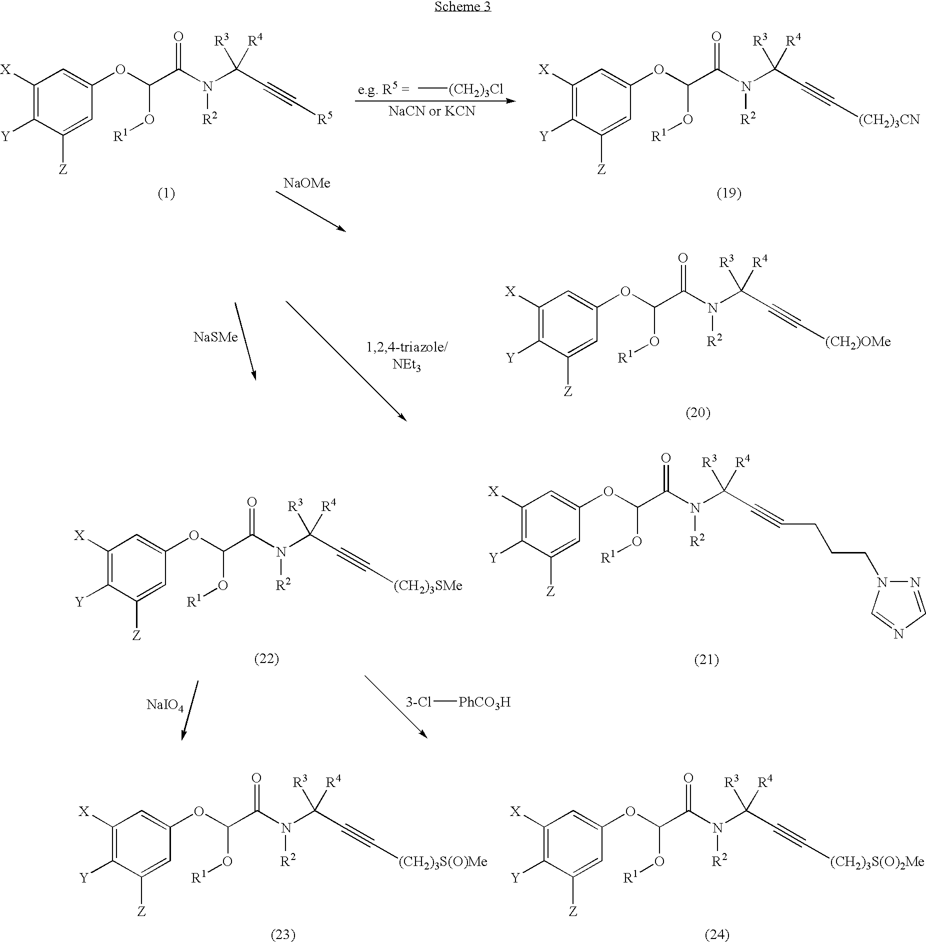

The compounds of formula (1) are active fungicides and may be used to control one or more of the following pathogens: Pyricularia oryzae (Magnaporthe grisea) on rice and wheat and other Pyricularia spp. on other hosts; Puccinia triticina (or recondita), Puccinia striiformis and other rusts on wheat, Puccinia hordei, Puccinia striiformis and other rusts on barley, and rusts on other hosts (for example turf, rye, coffee, pears, apples, peanuts, sugar beet, vegetables and ornamental plants); Erysiphe cichoracearum on cucurbits (for example melon); Blumeria (or Erysiphe) graminis (powdery mildew) on barley, wheat, rye and turf and other powdery mildews on various hosts, such as Sphaerotheca macularis on hops, Sphaerotheca fusca (Sphaerotheca fuliginea) on cucurbits (for example cucumber), Leveillula taurica on tomatoes, aubergine and green pepper, Podosphaera leucotricha on apples and Uncinula necator on vines; Cochliobolus spp., Helminthosporium spp., Drechslera spp. (Pyrenophora spp.), Rhynchosporium spp., Mycosphaerella graminicola (Septoria tritici) and Phaeosphaeria nodorum (Stagonospora nodorum or Septoria nodorum), Pseudocercosporella herpotrichoides and Gaeumannomyces graminis on cereals (for example wheat, barley, rye), turf and other hosts; Cercospora arachidicola and Cercosporidium personatum on peanuts and other Cercospora spp. on other hosts, for example sugar beet, bananas, soya beans and rice; Botrytis cinerea (grey mould) on tomatoes, strawberries, vegetables, vines and other hosts and other Botrytis spp. on other hosts; Alternaria spp. on vegetables (for example carrots), oil-seed rape, apples, tomatoes, potatoes, cereals (for example wheat) and other hosts; Venturia spp. (including Venturia inaequalis (scab)) on apples, pears, stone fruit, tree nuts and other hosts; Cladosporium spp. on a range of hosts including cereals (for example wheat) and tomatoes; Monilinia spp. on stone fruit, tree nuts and other hosts; Didymella spp. on tomatoes, turf, wheat, cucurbits and other hosts; Phoma spp. on oil-seed rape, turf, rice, potatoes, wheat and other hosts; Aspergillus spp. and Aureobasidium spp. on wheat, lumber and other hosts; Ascochyta spp. on peas, wheat, barley and other hosts; Stemphylium spp. (Pleospora spp.) on apples, pears, onions and other hosts; summer diseases (for example bitter rot (Glomerella cingulata), black rot or frogeye leaf spot (Botryosphaeria obtusa), Brooks fruit spot (Mycosphaerella pomi), Cedar apple rust (Gymnosporangium juniperi-virginianae), sooty blotch (Gloeodes pomigena), flyspeck (Schizothyrium pomi) and white rot (Botryosphaeria dothidea)) on apples and pears; Plasmopara viticola on vines; other downy mildews, such as Bremia lactucae on lettuce, Peronospora spp. on soybeans, tobacco, onions and other hosts, Pseudoperonospora humuli on hops and Pseudoperonospora cubensis on cucurbits; Pythium spp. (including Pythium ultimum) on turf and other hosts; Phytophthora infestans on potatoes and tomatoes and other Phytophthora spp. on vegetables, strawberries, avocado, pepper, ornamentals, tobacco, cocoa and other hosts; Thanatephorus cucumeris on rice and turf and other Rhizoctonia spp. on various hosts such as wheat and barley, peanuts, vegetables, cotton and turf; Sclerotinia spp. on turf, peanuts, potatoes, oil-seed rape and other hosts; Sclerotium spp. on turf, peanuts and other hosts; Gibberella fujikuroi on rice; Colletotrichum spp. on a range of hosts including turf, coffee and vegetables; Laetisaria fuciformis on turf; Mycosphaerella spp. on bananas, peanuts, citrus, pecans, papaya and other hosts; Diaporthe spp. on citrus, soybean, melon, pears, lupin and other hosts; Elsinoe spp. on citrus, vines, olives, pecans, roses and other hosts; Verticillium spp. on a range of hosts including hops, potatoes and tomatoes; Pyrenopeziza spp. on oil-seed rape and other hosts; Oncobasidium theobromae on cocoa causing vascular streak dieback; Fusarium spp., Typhula spp., Microdochium nivale, Ustilago spp., Urocystis spp., Tilletia spp. and Claviceps purpurea on a variety of hosts but particularly wheat, barley, turf and maize; Ramularia spp. on sugar beet, barley and other hosts; post-harvest diseases particularly of fruit (for example Penicillium digitatum, Penicillium italicum and Trichoderma viride on oranges, Colletotrichum musae and Gloeosporium musarum on bananas and Botrytis cinerea on grapes); other pathogens on vines, notably Eutypa lata, Guignardia bidwellii, Phellinus igniarus, Phomopsis viticola, Pseudopeziza tracheiphila and Stereum hirsutum; other pathogens on trees (for example Lophodermium seditiosum) or lumber, notably Cephaloascus fragrans, Ceratocystis spp., Ophiostoma piceae, Penicillium spp., Trichoderma pseudokoningii, Trichoderma viride, Trichoderma harzianum, Aspergillus niger, Leptographium lindbergi and Aureobasidium pullulans; and fungal vectors of viral diseases (for example Polymyxa graminis on cereals as the vector of barley yellow mosaic virus (BYMV) and Polymyxa betae on sugar beet as the vector of rhizomania).

The compounds of formula (1) show particularly good activity against the Oomycete class of pathogens such as Phytophthora infestans, Plasmopara species, e.g. Plasmopara viticola and Pythium species e.g. Pythium ultimum.

A compound of formula (1) may move acropetally, basipetally or locally in plant tissue to be active against one or more fungi. Moreover, a compound of formula (1) may be volatile enough to be active in the vapour phase against one or more fungi on the plant.

The invention therefore provides a method of combating or controlling phytopathogenic fungi which comprises applying a fungicidally effective amount of a compound of formula (1), or a composition containing a compound of formula (1), to a plant, to a seed of a plant, to the locus of the plant or seed or to soil or any other plant growth medium, e.g. nutrient solution.

The term “plant” as used herein includes seedlings, bushes and trees. Furthermore, the fungicidal method of the invention includes protectant, curative, systemic, eradicant and antisporulant treatments.

The compounds of formula (1) are preferably used for agricultural, horticultural and turfgrass purposes in the form of a composition.

In order to apply a compound of formula (1) to a plant, to a seed of a plant, to the locus of the plant or seed or to soil or any other growth medium, a compound of formula (1) is usually formulated into a composition which includes, in addition to the compound of formula (1), a suitable inert diluent or carrier and, optionally, a surface active agent (SFA). SFAs are chemicals that are able to modify the properties of an interface (for example, liquid/solid, liquid/air or liquid/liquid interfaces) by lowering the interfacial tension and thereby leading to changes in other properties (for example dispersion, emulsification and wetting). It is preferred that all compositions (both solid and liquid formulations) comprise, by weight, 0.0001 to 95%, more preferably 1 to 85%, for example 5 to 60%, of a compound of formula (1). The composition is generally used for the control of fungi such that a compound of formula (1) is applied at a rate of from 0.1 g to 10 kg per hectare, preferably from 1 g to 6 kg per hectare, more preferably from 1 g to 1 kg per hectare.

When used in a seed dressing, a compound of formula (1) is used at a rate of 0.0001 g to 10 g (for example 0.001 g or 0.05 g), preferably 0.005 g to 10 g, more preferably 0.005 g to 4 g, per kilogram of seed.

In another aspect the present invention provides a fungicidal composition comprising a fungicidally effective amount of a compound of formula (1) and a suitable carrier or diluent therefor.

In a still further aspect the invention provides a method of combating and controlling fungi at a locus, which comprises treating the fungi, or the locus of the fungi with a fungicidally effective amount of a composition comprising a compound of formula (1).

The compositions can be chosen from a number of formulation types, including dustable powders (DP), soluble powders (SP), water soluble granules (SG), water dispersible granules (WG), wettable powders (WP), granules (GR) (slow or fast release), soluble concentrates (SL), oil miscible liquids (OL), ultra low volume liquids (UL), emulsifiable concentrates (EC), dispersible concentrates (DC), emulsions (both oil in water (EW) and water in oil (EO)), micro-emulsions (ME), suspension concentrates (SC), aerosols, fogging/smoke formulations, capsule suspensions (CS) and seed treatment formulations. The formulation type chosen in any instance will depend upon the particular purpose envisaged and the physical, chemical and biological properties of the compound of formula (1).

Dustable powders (DP) may be prepared by mixing a compound of formula (1) with one or more solid diluents (for example natural clays, kaolin, pyrophyllite, bentonite, alumina, montmorillonite, kieselguhr, chalk, diatomaceous earths, calcium phosphates, calcium and magnesium carbonates, sulphur, lime, flours, talc and other organic and inorganic solid carriers) and mechanically grinding the mixture to a fine powder.

Soluble powders (SP) may be prepared by mixing a compound of formula (1) with one or more water-soluble inorganic salts (such as sodium bicarbonate, sodium carbonate or magnesium sulphate) or one or more water-soluble organic solids (such as a polysaccharide) and, optionally, one or more wetting agents, one or more dispersing agents or a mixture of said agents to improve water dispersibility/solubility. The mixture is then ground to a fine powder. Similar compositions may also be granulated to form water soluble granules (SG).

Wettable powders (WP) may be prepared by mixing a compound of formula (1) with one or more solid diluents or carriers, one or more wetting agents and, preferably, one or more dispersing agents and, optionally, one or more suspending agents to facilitate the dispersion in liquids. The mixture is then ground to a fine powder. Similar compositions may also be granulated to form water dispersible granules (WG).

Granules (GR) may be formed either by granulating a mixture of a compound of formula (1) and one or more powdered solid diluents or carriers, or from pre-formed blank granules by absorbing a compound of formula (1) (or a solution thereof, in a suitable agent) in a porous granular material (such as pumice, attapulgite clays, fuller's earth, kieselguhr, diatomaceous earths or ground corn cobs) or by adsorbing a compound of formula (1) (or a solution thereof, in a suitable agent) on to a hard core material (such as sands, silicates, mineral carbonates, sulphates or phosphates) and drying if necessary. Agents which are commonly used to aid absorption or adsorption include solvents (such as aliphatic and aromatic petroleum solvents, alcohols, ethers, ketones and esters) and sticking agents (such as polyvinyl acetates, polyvinyl alcohols, dextrins, sugars and vegetable oils). One or more other additives may also be included in granules (for example an emulsifying agent, wetting agent or dispersing agent).

Dispersible Concentrates (DC) may be prepared by dissolving a compound of formula (1) in water or an organic solvent, such as a ketone, alcohol or glycol ether. These solutions may contain a surface active agent (for example to improve water dilution or prevent crystallisation in a spray tank).

Emulsifiable concentrates (EC) or oil-in-water emulsions (EW) may be prepared by dissolving a compound of formula (1) in an organic solvent (optionally containing one or more wetting agents, one or more emulsifying agents or a mixture of said agents). Suitable organic solvents for use in ECs include aromatic hydrocarbons (such as alkylbenzenes or alkylnaphthalenes, exemplified by SOLVESSO 100, SOLVESSO 150 and SOLVESSO 200; SOLVESSO is a Registered Trade Mark), ketones (such as cyclohexanone or methylcyclohexanone), alcohols (such as benzyl alcohol, furfuryl alcohol or butanol), N-alkylpyrrolidones (such as N-methylpyrrolidone or N-octyl-pyrrolidone), dimethyl amides of fatty acids (such as C₈-C₁₀ fatty acid dimethylamide) and chlorinated hydrocarbons. An EC product may spontaneously emulsify on addition to water, to produce an emulsion with sufficient stability to allow spray application through appropriate equipment. Preparation of an EW involves obtaining a compound of formula is (1) either as a liquid (if it is not a liquid at room temperature, it may be melted at a reasonable temperature, typically below 70° C.) or in solution (by dissolving it in an appropriate solvent) and then emulsifying the resultant liquid or solution into water containing one or more SFAs, under high shear, to produce an emulsion. Suitable solvents for use in EWs include vegetable oils, chlorinated hydrocarbons (such as chlorobenzenes), aromatic solvents (such as alkylbenzenes or alkylnaphthalenes) and other appropriate organic solvents that have a low solubility in water.

Microemulsions (ME) may be prepared by mixing water with a blend of one or more solvents with one or more SFAs, to produce spontaneously a thermodynamically stable isotropic liquid formulation. A compound of formula (1) is present initially in either the water or the solvent/SFA blend. Suitable solvents for use in MEs include those hereinbefore described for use in in ECs or in EWs. An ME may be either an oil-in-water or a water-in-oil system (which system is present may be determined by conductivity measurements) and may be suitable for mixing water-soluble and oil-soluble pesticides in the same formulation. An ME is suitable for dilution into water, either remaining as a microemulsion or forming a conventional oil-in-water emulsion.

Suspension concentrates (SC) may comprise aqueous or non-aqueous suspensions of finely divided insoluble solid particles of a compound of formula (1). SCs may be prepared by ball or bead milling the solid compound of formula (1) in a suitable medium, optionally with one or more dispersing agents, to produce a fine particle suspension of the compound. One or more wetting agents may be included in the composition and a suspending agent may be included to reduce the rate at which the particles settle. Alternatively, a compound of formula (1) may be dry milled and added to water, containing agents hereinbefore described, to produce the desired end product.

Aerosol formulations comprise a compound of formula (1) and a suitable propellant (for example n-butane). A compound of formula (1) may also be dissolved or dispersed in a suitable medium (for example water or a water miscible liquid, such as n-propanol) to provide compositions for use in non-pressurised, hand-actuated spray pumps.

A compound of formula (1) may be mixed in the dry state with a pyrotechnic mixture to form a composition suitable for generating, in an enclosed space, a smoke containing the compound.

Capsule suspensions (CS) may be prepared in a manner similar to the preparation of EW formulations but with an additional polymerisation stage such that an aqueous dispersion of oil droplets is obtained, in which each oil droplet is encapsulated by a polymeric shell and contains a compound of formula (1) and, optionally, a carrier or diluent therefor. The polymeric shell may be produced by either an interfacial polycondensation reaction or by a coacervation procedure. The compositions may provide for controlled release of the compound of formula (1) and they may be used for seed treatment. A compound of formula (1) may also be formulated in a biodegradable polymeric matrix to provide a slow, controlled release of the compound.

A composition may include one or more additives to improve the biological performance of the composition (for example by improving wetting, retention or distribution on surfaces; resistance to rain on treated surfaces; or uptake or mobility of a compound of formula (1)). Such additives include surface active agents, spray additives based on oils, for example certain mineral oils or natural plant oils (such as soy bean and rape seed oil), and blends of these with other bio-enhancing adjuvants (ingredients which may aid or modify the action of a compound of formula (1)).

A compound of formula (1) may also be formulated for use as a seed treatment, for example as a powder composition, including a powder for dry seed treatment (DS), a water soluble powder (SS) or a water dispersible powder for slurry treatment (WS), or as a liquid composition, including a flowable concentrate (FS), a solution (LS) or a capsule suspension (CS). The preparations of DS, SS, WS, FS and LS compositions are very similar to those of, respectively, DP, SP, WP, SC and DC compositions described above. Compositions for treating seed may include an agent for assisting the adhesion of the composition to the seed (for example a mineral oil or a film-forming barrier).

Wetting agents, dispersing agents and emulsifying agents may be SFAs of the cationic, anionic, amphoteric or non-ionic type.

Suitable SFAs of the cationic type include quaternary ammonium compounds (for example cetyltrimethyl ammonium bromide), imidazolines and amine salts.

Suitable anionic SFAs include alkali metals salts of fatty acids, salts of aliphatic monoesters of sulphuric acid (for example sodium lauryl sulphate), salts of sulphonated aromatic compounds (for example sodium dodecylbenzenesulphonate, calcium dodecylbenzenesulphonate, butylnaphthalene sulphonate and mixtures of sodium di-isopropyl- and tri-isopropyl-naphthalene sulphonates), ether sulphates, alcohol ether sulphates (for example sodium laureth-3-sulphate), ether carboxylates (for example sodium laureth-3-carboxylate), phosphate esters (products from the reaction between one or more fatty alcohols and phosphoric acid (predominately mono-esters) or phosphorus pentoxide (predominately di-esters), for example the reaction between lauryl alcohol and tetraphosphoric acid; additionally these products may be ethoxylated), sulphosuccinamates, paraffin or olefine sulphonates, taurates and lignosulphonates.

Suitable SFAs of the amphoteric type include betaines, propionates and glycinates.

Suitable SFAs of the non-ionic type include condensation products of alkylene oxides, such as ethylene oxide, propylene oxide, butylene oxide or mixtures thereof, with fatty alcohols (such as oleyl alcohol or cetyl alcohol) or with alkylphenols (such as octylphenol, nonylphenol or octylcresol); partial esters derived from long chain fatty acids or hexitol anhydrides; condensation products of said partial esters with ethylene oxide; block polymers (comprising ethylene oxide and propylene oxide); alkanolamides; simple esters (for example fatty acid polyethylene glycol esters); amine oxides (for example lauryl dimethyl amine oxide); and lecithins.

Suitable suspending agents include hydrophilic colloids (such as polysaccharides, polyvinylpyrrolidone or sodium carboxymethylcellulose) and swelling clays (such as bentonite or attapulgite).

A compound of formula (1) may be applied by any of the known means of applying fungicidal compounds. For example, it may be applied, formulated or unformulated, to any part of the plant, including the foliage, stems, branches or roots, to the seed before it is planted or to other media in which plants are growing or are to be planted (such as soil surrounding the roots, the soil generally, paddy water or hydroponic culture systems), directly or it may be sprayed on, dusted on, applied by dipping, applied as a cream or paste formulation, applied as a vapour or applied through distribution or incorporation of a composition (such as a granular composition or a composition packed in a water-soluble bag) in soil or an aqueous environment.

A compound of formula (1) may also be injected into plants or sprayed onto vegetation using electrodynamic spraying techniques or other low volume methods, or applied by land or aerial irrigation systems.

Compositions for use as aqueous preparations (aqueous solutions or dispersions) are generally supplied in the form of a concentrate containing a high proportion of the active ingredient, the concentrate being added to water before use. These concentrates, which may include DCs, SCs, ECs, EWs, MEs SGs, SPs, WPs, WGs and CSs, are often required to withstand storage for prolonged periods and, after such storage, to be capable of addition to water to form aqueous preparations which remain homogeneous for a sufficient time to enable them to be applied by conventional spray equipment. Such aqueous preparations may contain varying amounts of a compound of formula (1) (for example 0.0001 to 10%, by weight) depending upon the purpose for which they are to be used.

A compound of formula (1) may be used in mixtures with fertilisers (for example nitrogen-, potassium- or phosphorus-containing fertilisers). Suitable formulation types include granules of fertiliser. The mixtures suitably contain up to 25% by weight of the compound of formula (1).

The invention therefore also provides a fertiliser composition comprising a fertiliser and a compound of formula (1).

The compositions of this invention may contain other compounds having biological activity, for example micronutrients or compounds having similar or complementary fungicidal activity or which possess plant growth regulating, herbicidal, insecticidal, nematicidal or acaricidal activity.

By including another fungicide, the resulting composition may have a broader spectrum of activity or a greater level of intrinsic activity than the compound of formula (1) alone. Further the other fungicide may have a synergistic effect on the fungicidal activity of the compound of formula (1).

The compound of formula (1) may be the sole active ingredient of the composition or it may be admixed with one or more additional active ingredients such as a pesticide, fungicide, synergist, herbicide or plant growth regulator where appropriate. An additional active ingredient may: provide a composition having a broader spectrum of activity or increased persistence at a locus; synergise the activity or complement the activity (for example by increasing the speed of effect or overcoming repellency) of the compound of formula (1); or help to overcome or prevent the development of resistance to individual components. The particular additional active ingredient will depend upon the intended utility of the composition.

Examples of fungicidal compounds which may be included in the composition of the invention are AC 382042 (N-(1-cyano-1,2-dimethylpropyl)-2-(2,4-dichlorophenoxy) propionamide), acibenzolar-S-methyl, alanycarb, aldimorph, anilazine, azaconazole, azafenidin, azoxystrobin, benalaxyl, benomyl, benthiavalicarb, biloxazol, bitertanol, blasticidin S, boscalid (new name for nicobifen), bromuconazole, bupirimate, captafol, captan, carbendazim, carbendazim chlorhydrate, carboxin, carpropamid, carvone, CGA 41396, CGA 41397, chinomethionate, chlorbenzthiazone, chlorothalonil, chlorozolinate, clozylacon, copper containing compounds such as copper oxychloride, copper oxyquinolate, copper sulphate, copper tallate, and Bordeaux mixture, cyamidazosulfamid, cyazofamid (IKF-916), cyflufenamid, cymoxanil, cyproconazole, cyprodinil, debacarb, di-2-pyridyl disulphide 1,1′-dioxide, dichlofluanid, diclocymet, diclomezine, dicloran, diethofencarb, difenoconazole, difenzoquat, diflumetorim, O,O-di-iso-propyl-S-benzyl thiophosphate, dimefluazole, dimetconazole, dimethirimol, dimethomorph, dimoxystrobin, diniconazole, dinocap, dithianon, dodecyl dimethyl ammonium chloride, dodemorph, dodine, doguadine, edifenphos, epoxiconazole, ethaboxam, ethirimol, ethyl (Z)-N-benzyl-N([methyl(methyl-thioethylideneaminooxycarbonyl)amino]thio)-β-alaninate, etridiazole, famoxadone, fenamidone, fenarimol, fenbuconazole, fenfuram, fenhexamid, fenoxanil (AC 382042), fenpiclonil, fenpropidin, fenpropimorph, fentin acetate, fentin hydroxide, ferbam, ferimzone, fluazinam, fludioxonil, flumetover, flumorph, fluoroimide, fluoxastrobin, fluquinconazole, flusilazole, flusulfamide, flutolanil, flutriafol, folpet, fosetyl-aluminium, fuberidazole, furalaxyl, furarmetpyr, guazatine, hexaconazole, hydroxyisoxazole, hymexazole, imazalil, imibenconazole, iminoctadine, iminoctadine triacetate, ipconazole, iprobenfos, iprodione, iprovalicarb, isopropanyl butyl carbamate, isoprothiolane, kasugamycin, kresoxim-methyl, LY186054, LY211795, LY 248908, mancozeb, maneb, mefenoxam, mepanipyrim, mepronil, metalaxyl, metalaxyl M, metconazole, metiram, metiram-zinc, metominostrobin, metrafenone, MON65500 (N-allyl-4,5-dimethyl-2-trimethylsilylthiophene-3-carboxamide), myclobutanil, NTN0301, neoasozin, nickel dimethyldithiocarbamate, nitrothale-isopropyl, nuarimol, ofurace, organomercury compounds, orysastrobin, oxadixyl, oxasulfuron, oxolinic acid, oxpoconazole, oxycarboxin, pefurazoate, penconazole, pencycuron, phenazin oxide, phosphorus acids, phthalide, picoxystrobin, polyoxin D, polyram, probenazole, prochloraz, procymidone, propamocarb, propamocarb hydrochloride, propiconazole, propineb, propionic acid, proquinazid, prothioconazole, pyraclostrobin, pyrazophos, pyrifenox, pyrimethanil, pyroquilon, pyroxyfur, pyrrolnitrin, quaternary ammonium compounds, quinomethionate, quinoxyfen, quintozene, silthiofam (MON 65500), S-imazalil, simeconazole, sipconazole, sodium pentachlorophenate, spiroxamine, streptomycin, sulphur, tebuconazole, tecloftalam, tecnazene, tetraconazole, thiabendazole, thifluzamide, 2-(thiocyanomethylthio)benzothiazole, thiophanate-methyl, thiram, tiadinil, timibenconazole, tolclofos-methyl, tolylfluanid, triadimefon, triadimenol, triazbutil, triazoxide, tricyclazole, tridemorph, trifloxystrobin, triflumizole, triforine, triticonazole, validamycin A, vapam, vinclozolin, XRD-563, zineb, ziram, zoxamide and compounds of the formulae:

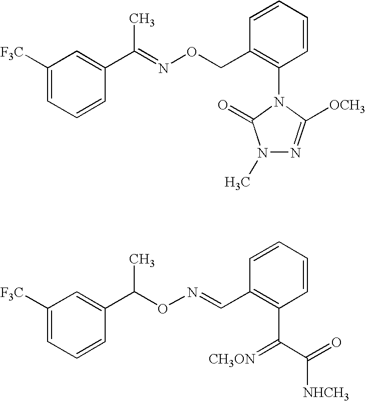

The compounds of formula (1) may be mixed with soil, peat or other rooting media for the protection of plants against seed-borne, soil-borne or foliar fungal diseases.

Some mixtures may comprise active ingredients, which have significantly different physical, chemical or biological properties such that they do not easily lend themselves to the same conventional formulation type. In these circumstances other formulation types may be prepared. For example, where one active ingredient is a water insoluble solid and the other a water insoluble liquid, it may nevertheless be possible to disperse each active ingredient in the same continuous aqueous phase by dispersing the solid active ingredient as a suspension (using a preparation analogous to that of an SC) but dispersing the liquid active ingredient as an emulsion (using a preparation analogous to that of an EW). The resultant composition is a suspoemulsion (SE) formulation.

The invention is illustrated by the following Examples in which the following abbreviations are used:

| | |
|---|---|
| ml = millilitres | DMSO = dimethylsulphoxide |
| g = grammes | DMF = N,N-dimethylformamide |
| ppm = parts per million | NMR = nuclear magnetic resonance |
| M⁺ = mass ion | HPLC = high performance liquid |
| s = singlet | chromatography |
| d = doublet | q = quartet |
| bs = broad singlet | m = multiplet |
| t = triplet | ppm = parts per million |

### EXAMPLE 1

This Example illustrates the preparation of 2-(3,5-dichlorophenoxy)-2-(methoxy)-N-(2-methylpent-3-yn-2-yl)acetamide (Compound No. 4, Table 2)

Step 1

To a solution of 2-(3,5-dichlorophenoxy)acetic acid (0.50 g) in dichloromethane (12 ml) at 0° C. was added 2 drops of DMF followed by oxalyl chloride (0.278 ml) dropwise. The solution was stirred at room temperature for 2 hours and then evaporated affording the acid chloride (0.66 g) as a pale yellow residue that was used straight away in the next step. A solution of the freshly prepared acid chloride in dichloromethane (10 ml) was added to a solution of t-butanol (1 ml) in triethylamine (2 ml) at 0° C. The resulting solution was stirred at room temperature and stored for 18 hours. The solvent was evaporated under reduced pressure and water added. The aqueous phase was extracted with ethyl acetate, the organic phase was washed with water, followed by aqueous saturated ammonium chloride and brine, and then dried over magnesium sulphate. The solvent was evaporated to give a brown oil (0.563 g), which was purified by flash column chromatography on silica gel (40-60) eluting with ethyl acetate:hexane (1:2), to give t-butyl 2-(3,5-dichlorophenoxy)acetate as a pale yellow oil (0.42 g).

¹H NMR (CDCl₃) δ ppm: 1.49 (9H,s); 4.49 (1H,s); 6.80 (2H,s); 6.99 (1H,s).

Step 2

To a solution of the product from Step 1 (0.42 g) in carbon tetrachloride (7 ml) at room temperature was added N-bromosuccinimide (0.271 g). The resulting yellow solution was heated to 60° C. and irradiated using a high-pressure mercury lamp UVL (˜30 W) for 3 hours. The reaction was cooled to 0° C., the succinimide filtered, and washed with further carbon tetrachloride. The solvent was evaporated to dryness affording of t-butyl 2-bromo-2-(3,5-dichlorophenoxy)acetate as a pale yellow solid (0.54 g).

¹H NMR (CDCl₃) δ ppm: 1.56 (9H,s); 6.29 (1H,s); 7.08 (2H,s); 7.17 (1H,s).

Step 3

To a solution of the product from Step 2 (0.10 g) in methanol (3 ml) at room temperature was added sodium methoxide (0.038 g). The resulting pale yellow solution was stirred for 3 hours. The solvent was evaporated, and then water and ethyl acetate were added. The aqueous phase was separated and re-extracted with ethyl acetate. The organic fractions were combined, dried over magnesium sulphate and evaporated, giving t-butyl 2-methoxy-2-(3,5-dichlorophenoxy)acetate as a pale yellow oil (0.048 g), which was used directly in the next step.

¹H NMR (CDCl₃) δ ppm: 1.49 (9H,s); 3.50 (3H,s); 5.32 (1H,s); 7.01 (2H,s); 7.05 (1H,s).

Step 4

To a solution of the product from Step 3 (0.048 g) in methanol (1 ml) at room temperature was added the solution of sodium hydroxide (0.0125 g) in water (0.5 ml). The resulting mixture was heated to reflux for 30 minutes and the solvent evaporated. Water and ethyl acetate were added, the aqueous phase separated, acidified with dilute hydrochloric acid and extracted with ethyl acetate. The organic phase was dried over magnesium sulphate, and evaporated to give 2-methoxy-2-(3,5-dichlorophenoxy)acetic acid (0.045 g) as a pale yellow oil, which was used directly in the next step without further purification.

¹H NMR (CDCl₃) δ ppm: 3.55 (3H,s); 5.51 (1H,s); 7.04 (2H,s); 7.09 (1H,s).

Step 5

Triethylamine (0.032 ml) was added to a stirred solution of 4-amino-4-methyl-pent-2-yne hydrochloride (0.024 g) in DMF (1 ml) giving a white suspension. 2-Methoxy-2-(3,5-dichlorophenoxy)acetic acid (0.045 mg) was added followed by 1-hydroxybenzo-triazole (0.025 g) and N-(3-dimethylaminopropyl)-N′-ethyl carbodiimide hydrochloride (0.035 g). The white suspension was stirred at room temperature for 3 hours, stored for 18 hours and water added. The aqueous phase was extracted with diethyl ether and the organic phase washed with water, saturated sodium bicarbonate and then brine, dried over magnesium sulphate and evaporated to give a pale yellow oil (0.040 g). This was purified by flash column chromatography on silica gel (40-60) eluting with ethyl acetate:hexane (1:4) to give the title product as a colourless oil (0.024 g).

¹H NMR (CDCl₃) δ ppm: 1.63 (3H,s); 1.64 (3H,s); 1.82 (3H,s); 3.50 (3H,s); 5.22 (1H,s); 6.68 (1H,bs); 7.05 (3H,s).

Preparation of 4-amino-4-methylpent-2-yne hydrochloride (for use in Step 5)

Stage 1

3-Amino-3-methylbutyne (commercially available as 90% aqueous solution; 16.6 g) was dissolved in dichloromethane (150 ml), dried over sodium sulphate and filtered to give a solution containing the amine (14.9 g). To the stirred solution of amine under an atmosphere of nitrogen at ambient temperature was added dry triethylamine (48.4 ml), 1,2-bis-(chlorodimethylsilyl)ethane (38.98 g) in dichloromethane (100 ml) was then added dropwise, maintaining the reaction temperature at 15° C. by cooling. The mixture was stirred for 3 hours and the colourless solid, which had formed during the reaction, was filtered from solution and the filtrate was evaporated under reduced pressure to give a paste. The paste was extracted into hexane and refiltered. The filtrate was evaporated under reduced pressure and the oil obtained was distilled to give 1-(1,1-dimethyl-2-propynyl)-2,2,5,5-tetramethyl-1-aza-2,5-disilacyclopentane, (21.5 g), b.p. 41° C. at 0.06 mm Hg pressure.

¹H NMR (CDCl₃) δ ppm: 0.16 (12H,s); 0.60 (4H,s); 1.48 (6H,s); 2.24 (1H,s).

Stage 2

The product from Step 1 (13.0 g) in dry tetrahydrofuran (140 ml) was cooled to −70° C. under an atmosphere of nitrogen with stirring and a solution of n-butyl lithium (23.1 ml of 2.5M solution in hexanes) was added at −65 to −70° C. during 5 minutes. The mixture was allowed to warm to −5° C. and methyl iodide (3.93 ml) was added dropwise over 10 minutes. The reaction mixture was allowed to warm to 10° C. when an exothermic reaction occurred. The mixture was maintained at 20° C. by cooling for 2 hours then evaporated under reduced pressure to a small volume. The residue was dissolved in hexane, filtered to remove the insoluble material and evaporated under reduced pressure to give 1-(1,1-dimethyl-2-butynyl)-2,2,5,5-tetramethyl-1-aza-2,5-disilacyclopentane as a yellow oil, (13.0 g).

¹H NMR (CDCl₃) δ ppm: 0.10 (12H,s); 0.56 (4H,s); 1.40 (6H,s); 1.72 (3H,s).

Stage 3

The product from Step 2 (13.0 g) was added slowly to aqueous hydrochloric acid (35 ml, 4M) at 0° C. with stirring. The emulsion formed was stirred for 0.5 hours then taken to pH14 with aqueous sodium hydroxide (4M) while maintaining the reaction mixture at 0° C. by cooling in ice. The aqueous mixture was extracted into dichloro-methane (three times) and the extracts combined, dried over sodium sulphate and filtered. The filtrate was made acidic by adding an excess of a saturated solution of hydrogen chloride in 1,4-dioxan. The mixture was concentrated under reduced pressure until a colourless precipitate was formed. Hexane was added to the suspension and the solid was filtered from solution. The solid was washed with dry diethyl ether and placed under vacuum to remove any residual solvents to give the required product as a colourless solid, (5.0 g).

¹H NMR (d₆-DMSO) δ ppm: 1.74 (6H,s); 1.82 (3H,s); 8.74 (3H,bs).

### EXAMPLE 2

This example illustrates the preparation of 2-(3,5-dichlorophenoxy)-2-(ethoxy)-N-(2-methylpent-3-yn-2-yl)acetamide (Compound No. 4 of Table 1)

Step 1

Potassium t-butoxide (1.38 g) was dissolved in t-butyl alcohol (13 ml). The mixture was stirred for 15 minutes at room temperature and 3,5-dichlorophenol (2.0 g) added, followed by ethyl 2-bromo-2-ethoxyacetate (2.6 g). The reaction was exothermic with separation of potassium bromide. The reaction was stirred for 8 hours and then poured into water (45 ml) and extracted with chloroform (10 ml). The organic phase was washed with water, dried over magnesium sulphate and evaporated to give a colourless oil which was purified by flash column chromatography on silica gel (40-60) eluting with using ethyl acetate/hexane to give ethyl 2-3,5-dichlorophenoxy)-2-(ethoxy)acetate as a colourless oil (1.925 g).

¹H NMR (CDCl₃) δ ppm: 1.26 (3H,t); 1.31 (3H,t); 3.73 (1H, m); 3.81 (1H,m); 4.30 (2H,q); 5.48 (1H,s); 7.00 (2H,s); 7.06 (1H,s).

Step 2

To the product from Step 1 (1.8 g) in methanol (30 ml) at room temperature was added a solution of sodium hydroxide (0.49 g) in water (10 ml). The resulting mixture was heated to reflux for 15 minutes and the solvent evaporated, then water and ethyl acetate were added. The aqueous phase was separated, acidified with dilute hydrochloric acid and extracted with ethyl acetate. The organic phase was dried over magnesium sulphate and evaporated to give 2-(3,5-dichlorophenoxy)-2-(ethoxy)acetic acid (1.515 g) as a white solid.

¹H NMR (CDCl₃) δ ppm: 1.29 (3H,t); 3.75 (1H,m); 3.86 (1H,m); 5.54 (1H,s); 7.03 (2H,s); 7.09 (1H,s).

Step 3

Triethylamine (0.264 ml) was added to a stirred solution of 4-amino-4-methyl-pent-2-yne hydrochloride (0.253 g) in DMF (7 ml) giving a white suspension. The product from Step 2 (0.5 g) was added followed by 1-hydroxybenzotriazole (0.256 g) and N-(3-dimethylaminopropyl)-N′-ethyl carbodiimide hydrochloride (0.363 g). The white suspension was stirred at room temperature for 3 hours, stored for 18 hours, then water was added and the aqueous phase extracted with diethyl ether. The organic phase was washed with water, saturated sodium bicarbonate and then brine, dried over MgSO₄, and evaporated to give a white solid. This was recrystallised from hexane to give the title product as a white powder (0.324 g), m.p. 76.5° C.

¹H NMR (CDCl₃) δ ppm: 1.29 (3H,t); 1.57 (3H,s); 1.64 (6H,s); 3.67 (1H,m); 3.84 (1H,m); 5.28 (1H,s); 6.68 (1H,bs); 7.06 (2H,s); 7.27 (1H,s).

### EXAMPLE 3

This example illustrates the preparation of 2-(3,5-dichlorophenoxy)-2-(ethoxy)-N-(1-tert-butyldimethylsilyloxy-4-methylpent-2-yn-4-yl)acetamide (Compound No. 4 of Table 17)

Step 1

1-(1,1-Dimethyl-2-propynyl)-2,2,5,5-tetramethyl-1-aza-2,5-disilacyclopentane (22.6 g) in dry tetrahydrofuran (250 ml) was cooled to −50° C. under an atmosphere of nitrogen with stirring and a solution of n-butyl lithium (44 ml, 2.5M solution in hexanes) was added dropwise over 10 minutes. The mixture was stirred for 0.5 hour, allowed to warm to −20° C. then formaldehyde gas was bubbled through the mixture until no starting material remained as determined by glc analysis. On completion of reaction, the mixture was treated with water, the ether phase separated, the aqueous phase extracted with ethyl acetate (twice) and the organic extracts combined and washed with water (three times). The organic extract was dried over magnesium sulphate and evaporated under reduced pressure to give (1-hydroxy-4-methylpent-2-yn-4-yl)-2,2,5,5-tetramethyl-1-aza-2,5-disilacyclopentane, (24.96 g), as a pale yellow liquid.

¹H NMR (CDCl₃) δ ppm: 0.00 (12H,s); 0.46 (4H,s); 1.32 (6H,s); 4.08 (2H,s); OH not observed.

Step 2

The product from Step 1 (24.96 g) was treated with dilute aqueous hydrochloric acid (300 ml) and stirred at ambient temperature for 0.5 hour. The mixture was washed with diethyl ether (twice), the aqueous phase was evaporated under reduced pressure, distilled with toluene (twice) to remove residual water and the residual solid obtained was triturated with hexane to give 4-amino-1-hydroxy-4-methylpent-2-yne hydrochloride, (13.1 g), as a cream coloured solid.

¹H NMR (CDCl₃) δ ppm: 1.48 (6H,s); 4.06 (2H,s); 5.32 (1H,s); 8.64 (3H,s).

Step 3

4-Amino-1-hydroxy-4-methylpent-2-yne hydrochloride (4.40 g) was dissolved in dry DMF (100 ml) and triethylamine (4.44 ml) was added. The suspension was stirred at ambient temperature for 10 minutes, imidazole (4.93 g) was added followed by tert-butyl-dimethylsilyl chloride (5.24 g) in dry DMF (40 ml). The mixture was stirred at ambient temperature for 18 hours, diluted with water and extracted with diethyl ether (three times). The organic extracts were combined, washed with water (twice), dried over magnesium sulphate and evaporated under reduced pressure to give 4-amino-1-tert-butyldimethylsilyloxy-4-methylpent-2-yne, (6.88 g), as a yellow liquid.

¹H NMR (CDCl₃) δ ppm: 0.04 (6H,s); 0.84 (9H,s); 1.30 (6H,s); 4.22 (2H,s).

Step 4

Triethylamine (0.119 ml) was added to a stirred solution of the product from Step 3 (0.155 g) in DMF (2 ml) giving a white suspension. Freshly prepared 2-ethoxy-2-(3,5-dichlorophenoxy)acetic acid (0.18 g) was added in DMF (2 ml) followed by N-hydroxy-benzotriazole (0.092 g) and finally N-(3-dimethylaminopropyl)-N′-ethyl carbodiimide hydrochloride (0.131 g). The white suspension was stirred at room temperature for 2 hours, and then stored for 2 days. Water was added and the aqueous phase was extracted with ethyl acetate. The organic phases were combined, washed with water and dried over magnesium sulphate, and evaporated to give yellow oil (0.317 g). This was purified by flash column chromatography on silica gel (40-60) eluting with ethyl acetate:hexane (1:4), to give the title product as colourless oil (0.138 g).

¹H NMR (CDCl₃) δ ppm: 0.12 (6H,s); 0.91 (9H,s); 1.28 (3H,t); 1.65 (3H,s); 1.67 (3H,s); 3.66 (1H,m); 3.83 (1H,m); 4.33 (2H,s); 5.27 (1H,s); 6.69 (1H,bs); 7.04 (3H,m).

### EXAMPLE 4

This example illustrates the preparation of 2-(3,5-dichlorophenoxy)-2-(ethoxy)-N-(1-hydroxy-4-methylpent-2-yn-4-yl)acetamide (Compound No. 4 of Table 9).

To a solution of 2-(3,5-dichlorophenoxy)-2-(ethoxy)-N-(1-tert-butyldimethylsilyloxy-4-methylpent-2-yn-4-yl)acetamide (0.095 g) in THF (2 ml) was added tetrabutylammonium fluoride (0.402 ml of a 1.0 M solution in THF) dropwise over 5 minutes at 0° C. The mixture was stirred at room temperature for 2 hours, the solvent was evaporated and the residue was extracted with ethyl acetate. The ethyl acetate solution was washed with ammonium chloride solution and brine, dried over magnesium sulphate, and evaporated to give a colourless oil (0.095 g). This was purified by flash column chromatography on silica gel (40-60) eluting with ethyl acetate:hexane (1:1) to give the title compound as colourless oil (0.056 g).

¹H NMR (CDCl₃) δ ppm: 1.28 (3H,t); 1.65 (6H,s); 3.67 (1H,m); 3.84 (1H,m); 4.27 (2H,s); 5.29 (1H,s); 6.70 (1H,bs); 7.05 (3H,m).

TABLE 21

| | | (Solvent): ¹H NMR chemical shifts in ppm from |
|---|---|---|
| Compound | Table | TMS, or melting point (mpt) or refractive index |
| No. | No. | (N_{D}³⁰) |
| 4 | 1 | (CDCl₃): 1.28(t, 3H), 1.63(s, 3H), 1.64(s, 3H), |
| | | 1.82(s, 3H), 3.67(m, 1H), 3.84(m, 1H), 5.28(s, 1H), |
| | | 6.68(bs, 1H), 7.06(m, 3H) |
| 4 | 2 | (CDCl₃): 1.63(s, 3H), 1.64(s, 3H), 1.82(s, 3H), |
| | | 3.50(s, 3H), 5.22(s, 1H), 6.68(bs, 1H), 7.05(s, 3H) |
| 4 | 5 | Mpt. 67-70° C. |
| 2 | 6 | Mpt. 76-80° C. |
| 4 | 6 | n_{D}³⁰=1.5291 |
| 8 | 6 | n_{D}³⁰=1.5254 |
| 4 | 9 | (CDCl₃): 1.28(t, 3H), 1.65(s, 6H), 3.67(m, 1H), |
| | | 3.84(m, 1H), 4.27(s, 2H), 5.29(s, 1H), 6.70(bs, 1H), |
| | | 7.05(m, 3H) |
| 4 | 13 | (CDCl₃): 1.28(t, 3H), 1.67(s, 6H), 3.37(s, 3H), |
| | | 3.67(m, 1H), 3.84(m, 1H), 4.11(s, 2H), 5.29(s, 1H), |
| | | 6.68(bs, 1H), 7.04(m, 3H) |
| 4 | 17 | (CDCl₃): 0.12(s, 6H), 0.91(s, 9H), 1.28(t, 3H), |
| | | 1.65(s, 3H), 1.67(s, 3H), 3.66(m, 1H), 3.83(m, 1H), |
| | | 4.33(s, 2H), 5.27(s, 1H), 6.69(bs, 1H), 7.04(m, 3H). |

### EXAMPLE 5

This Example illustrates the fungicidal properties of compounds of formula (1).

The compounds were tested in a leaf disk assay, with methods described below. The test compounds were dissolved in DMSO and diluted into water to 200 ppm. In the case of the test on Pythium ultimum, they were dissolved in DMSO and diluted into water to 20 ppm.

Erysiphe graminis f.sp. hordei (barley powdery mildew): Barley leaf segments were placed on agar in a 24-well plate and sprayed with a solution of the test compound. After allowing to dry completely, for between 12 and 24 hours, the leaf disks were inoculated with a spore suspension of the fungus. After appropriate incubation the activity of a compound was assessed four days after inoculation as preventive fungicidal activity.

Erysiphe graminis f.sp. tritici (wheat powdery mildew): Wheat leaf segments were placed on agar in a 24-well plate and sprayed with a solution of the test compound. After allowing to dry completely, for between 12 and 24 hours, the leaf disks were inoculated with a spore suspension of the fungus. After appropriate incubation the activity of a compound was assessed four days after inoculation as preventive fungicidal activity.

Puccinia recondita f.sp. tritici (wheat brown rust): Wheat leaf segments were placed on agar in a 24-well plate and sprayed with a solution of the test compound. After allowing to dry completely, for between 12 and 24 hours, the leaf disks were inoculated with a spore suspension of the fungus. After appropriate incubation the activity of a compound was assessed nine days after inoculation as preventive fungicidal activity.

Septoria nodorum (wheat glume blotch): Wheat leaf segments were placed on agar in a 24-well plate and sprayed with a solution of the test compound. After allowing to dry completely, for between 12 and 24 hours, the leaf disks were inoculated with a spore suspension of the fungus. After appropriate incubation the activity of a compound was assessed four days after inoculation as preventive fungicidal activity.

Pyrenophora teres (barley net blotch): Barley leaf segments were placed on agar in a 24 well plate and sprayed with a solution of the test compound. After allowing to dry completely, for between 12 and 24 hours, the leaf disks were inoculated with a spore suspension of the fungus. After appropriate incubation the activity of a compound was assessed four days after inoculation as preventive fungicidal activity.

Pyricularia oryzrae (rice blast): Rice leaf segments were placed on agar in a 24-well plate and sprayed with a solution of the test compound. After allowing to dry completely, for between 12 and 24 hours, the leaf disks were inoculated with a spore suspension of the fungus. After appropriate incubation the activity of a compound was assessed four days after inoculation as preventive fungicidal activity.

Botrytis cinerea (grey mould): Bean leaf disks were placed on agar in a 24-well plate and sprayed with a solution of the test compound. After allowing to dry completely, for between 12 and 24 hours, the leaf disks were inoculated with a spore suspension of the fungus. After appropriate incubation the activity of a compound was assessed four days after inoculation as preventive fungicidal activity.

Phytophthora infestans (late blight of potato on tomato): Tomato leaf disks were placed on water agar in a 24-well plate and sprayed with a solution of the test compound. After allowing to dry completely, for between 12 and 24 hours, the leaf disks were inoculated with a spore suspension of the fungus. After appropriate incubation the activity of a compound was assessed four days after inoculation as preventive fungicidal activity.

Plasmopara viticola (downy mildew of grapevine): Grapevine leaf disks were placed on agar in a 24-well plate and sprayed a solution of the test compound. After allowing to dry completely, for between 12 and 24 hours, the leaf disks were inoculated with a spore suspension of the fungus. After appropriate incubation the activity of a compound was assessed seven days after inoculation as preventive fungicidal activity.

Pythium ultimum (Damping off): Mycelial fragments of the fungus, prepared from a fresh liquid culture, were mixed into potato dextrose broth. A solution of the test compound in dimethyl sulphoxide was diluted with water to 20 ppm then placed into a 96-well microtiter plate and the nutrient broth containing the fungal spores was added. The test plate was incubated at 24° C. and the inhibition of growth was determined photometrically after 48 hours.

The following compounds gave greater than 60% control of disease (number of compound first, followed by table number in brackets):

Plasmopara viticola, compounds 4 (1), 4 (2), 4 (5), 2 (6), 4 (6), 4 (9), 4 (13), 4 (17); Phytophthora infestans, compounds 4 (1), 4 (2), 4 (5), 4 (9), 4 (17); Erysiphe graminis f.sp. hordei, compounds 4 (5), 2 (6); Erysiphe graminis f.sp. tritici, compound 4 (9), 4 (13), 4 (17); Septoria nodorum, compound 8 (6), 4 (13); Pyricularia oryzae, compound 2 (6); Pyrenophora teres, compound 8 (6); Pythium ultimum, compounds 4 (1), 4 (2), 4 (5), 2 (6), 4 (6), 8 (6), 4 (9), 4 (13).

1. A compound for use as a plant fungicide of the general formula (1): 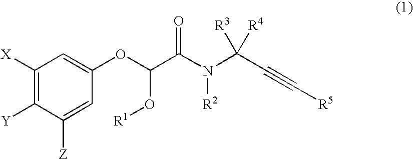
wherein
X, Y and Z are independently H, halogen, C₁₋₄ alkyl, halo(C₁₋₄)alkyl, C₂₋₄ alkenyl, halo(C₂₋₄)alkenyl, C₂₋₄ alkynyl, halo(C₂₋₄)alkynyl, C₁₋₄ alkoxy, halo(C₁₋₄)alkoxy, —S(O)ₙ(C₁₋₄)alkyl where n is 0, 1 or 2 and the alkyl group is optionally substituted with fluoro, —OSO₂(C₁₋₄)alkyl where the alkyl group is optionally substituted with fluoro, cyano, nitro, C₁₋₄ alkoxycarbonyl, —CONR′R″, —COR′, —NR′COR″ or —NR′COOR′″ where R′ and R″ are independently H or C₁₋₄ alkyl and R′″ is C₁₋₄ alkyl, provided that at least one of X and Z is other than H;
R¹ is a straight-chain C₁₋₄ alkyl group;
R² is H, C₁₋₄ alkyl, C₁₋₄ alkoxymethyl or benzyloxymethyl in which the phenyl ring of the benzyl moiety is optionally substituted with C₁₋₄ alkoxy;
R³ and R⁴ are independently H, C₁₋₃ alkyl, C₂₋₃ alkenyl or C₂₋₃ alkynyl provided that both are not H and that when both are other than H their combined total of carbon atoms does not exceed 4, or
R³ and R⁴ join with the carbon atom to which they are attached to form a 3 or 4 membered carbocyclic ring optionally containing one O, S or N atom and optionally substituted with halo or C₁₋₄ alkyl; and
R⁵ is H, C₁₋₄ alkyl or C₃₋₆ cycloalkyl in which the alkyl or cycloalkyl group is optionally substituted with halo, hydroxy, C₁₋₆ alkoxy, cyano, C₁₋₄ alkylcarbonyloxy, aminocarbonyloxy, mono- or di(C₁₋₄)alkylaminocarbonyloxy, —S(O)ₙ(C₁₋₆)alkyl where n is 0, 1 or 2, triazolyl, tri(C₁₋₄)-alkylsilyloxy, optionally substituted phenoxy, optionally substituted thienyloxy, optionally substituted benzyloxy or optionally substituted thienylmethoxy, or
R⁵ is optionally substituted phenyl, optionally substituted thienyl or optionally substituted benzyl,
in which the optionally substituted phenyl and thienyl rings of the R⁵ values are optionally substituted with one, two or three substituents selected from halo, hydroxy, mercapto, C₁₋₄ alkyl, C₂₋₄ alkenyl, C₂₋₄ alkynyl, C₁₋₄ alkoxy, C₂₋₄ alkenyloxy, C₂₋₄ alkynyloxy, halo(C₁₋₄)alkyl, halo(C₁₋₄)alkoxy, C₁₋₄ alkylthio, halo(C₁₋₄)alkylthio, hydroxy(C₁₋₄)alkyl, C₁₋₄ alkoxy(C₁₋₄)alkyl, C₃₋₆ cycloalkyl, C₃₋₆ cycloalkyl(C₁₋₄)alkyl, phenoxy, benzyloxy, benzoyloxy, cyano, isocyano, thiocyanato, isothiocyanato, nitro, —NR^{m}Rⁿ, —NHCOR^{m}, —NHCONR^{m}Rⁿ, —CONR^{m}Rⁿ, —SO₂R^{m}, —OSO₂R^{m}, —COR^{m}, —CR^{m}═NRⁿ or —N═CR^{m}Rⁿ, in which R^{m} and Rⁿ are independently hydrogen, C₁₋₄ alkyl, halo(C₁₋₄)alkyl, C₁₋₄ alkoxy, halo(C₁₋₄)alkoxy, C₁₋₄ alkylthio, C₃₋₆ cycloalkyl, C₃₋₆ cycloalkyl(C₁₋₄)alkyl, phenyl or benzyl, the phenyl and benzyl groups being optionally substituted with halogen, C₁₋₄ alkyl or C₁₋₄ alkoxy.

2. The compound of claim 1 wherein X, Y and Z are all chloro or methyl, or X and Z are both chloro or bromo and Y is H or methyl, or X and Z are both methyl or methoxy and Y is H, chloro, bromo or alkylthio, or X is methoxy, Y is H and Z is cyano or chloro, or X is methyl, Y is H and Z is ethyl, or X is chloro, bromo or trifluoromethyl and both Y and Z are H.

3. The compound of claim 1 wherein R¹ is methyl, ethyl, n-propyl, or n-butyl.

4. The compound of claim 1 wherein R¹ is methyl or ethyl.

5. The compound of claim 1 wherein R² is H.

6. The compound of claim 1 wherein both R³ and R⁴ are methyl.

7. The compound of claim 1 wherein R⁵ is H, methyl, hydroxymethyl, methoxymethyl, 1-methoxyethyl, tert-butyldimethylsilyloxymethyl, 3-cyanopropyl, 3-(1,2,4-triazol-1-yl)propyl, 3-methylthiopropyl, 3-methanesulphinylpropyl or 3-methanesulphonylpropyl.

8. The compound of claim 1 wherein
X, Y and Z are independently H, halogen, C₁₋₄ alkyl, halo(C₁₋₄)alkyl, C₂₋₄ alkenyl, halo(C₂₋₄)alkenyl, C₂₋₄ alkynyl, halo(C₂₋₄)alkynyl, C₁₋₄ alkoxy, halo(C₁₋₄)alkoxy, —S(O)ₙ(C₁₋₄)alkyl where n is 0, 1 or 2 and the alkyl group is optionally substituted with fluoro, —OSO₂(C₁₋₄)alkyl where the alkyl group is optionally substituted with fluoro, cyano, nitro, C₁₋₄ alkoxycarbonyl, —CONR′R″, —COR′ or —NR′COR″ where R′ and R″ are independently H or C₁₋₄ alkyl, provided that at least one of X and Z is other than H;
R¹ is a straight-chain C₁₋₄ alkyl group;
R² is H, C₁₋₄ alkyl, C₁₋₄ alkoxymethyl or benzyloxymethyl in which the phenyl ring of the benzyl moiety is optionally substituted with C₁₋₄ alkoxy;
R³ and R⁴ are independently H, C₁₋₃ alkyl, C₂₋₃ alkenyl or C₂₋₃ alkynyl provided that both are not H and that when both are other than H their combined total of carbon atoms does not exceed 4, or
R³ and R⁴ join with the carbon atom to which they are attached to form a 3 or 4 membered carbocyclic ring optionally containing one O, S or N atom and optionally substituted with halo or C₁₋₄ alkyl; and
R⁵ is H, C₁₋₄ alkyl or C₃₋₆ cycloalkyl in which the alkyl or cycloalkyl group is optionally substituted with halo, hydroxy, C₁₋₆ alkoxy, C₁₋₆ alkylthio, cyano, C₁₋₄ alkylcarbonyloxy, aminocarbonyloxy or mono- or di(C₁₋₄)alkylaminocarbonyloxy, tri(C₁₋₄)-alkylsilyloxy, optionally substituted phenoxy, optionally substituted thienyloxy, optionally substituted benzyloxy or optionally substituted thienylmethoxy, or
R⁵ is optionally substituted phenyl, optionally substituted thienyl or optionally substituted benzyl,
in which the optionally substituted phenyl and thienyl rings of the R⁵ values are optionally substituted with one, two or three substituents selected from halo, hydroxy, mercapto, C₁₋₄ alkyl, C₂₋₄ alkenyl, C₂₋₄ alkynyl, C₁₋₄ alkoxy, C₂₋₄ alkenyloxy, C₂₋₄ alkynyloxy, halo(C₁₋₄)alkyl, halo(C₁₋₄)alkoxy, C₁₋₄ alkylthio, halo(C₁₋₄)alkylthio, hydroxy(C₁₋₄)alkyl, C₁₋₄ alkoxy(C₁₋₄)alkyl, C₃₋₆ cycloalkyl, C₃₋₆ cycloalkyl(C₁₋₄)alkyl, phenoxy, benzyloxy, benzoyloxy, cyano, isocyano, thiocyanato, isothiocyanato, nitro, —NR^{m}Rⁿ, —NHCOR^{m}, —NHCONR^{m}Rⁿ, —CONR^{m}Rⁿ, —SO₂R^{m}, —OSO₂R^{m}, —COR^{m}, —CR^{m}═NRⁿ or —N═CR^{m}Rⁿ, in which R^{m} and Rⁿ are independently hydrogen, C₁₋₄ alkyl, halo(C₁₋₄)alkyl, C₁₋₄ alkoxy, halo(C₁₋₄)alkoxy, C₁₋₄ alkylthio, C₃₋₆ cycloalkyl, C₃₋₆ cycloalkyl(C₁₋₄)alkyl, phenyl or benzyl, the phenyl and benzyl groups being optionally substituted with halogen, C₁₋₄ alkyl or C₁₋₄ alkoxy.

9. The compound of claim 1 wherein X, Y and Z are all chloro or methyl, or X and Z are both chloro or bromo and Y is H or methyl, or X and Z are both methyl or methoxy and Y is H, chloro, bromo or alkylthio, or X is methoxy, Y is H and Z is cyano or chloro, or X is methyl, Y is H and Z is ethyl, or X is chloro, bromo or trifluoromethyl and both Y and Z are H; R¹ is methyl, ethyl, n-propyl or n-butyl; R² is H; R³ and R⁴ are both methyl; and R⁵ is H, methyl, hydroxymethyl, methoxymethyl, 1-methoxyethyl, tert-butyldimethylsilyloxymethyl, 3-cyanopropyl, 3-(1,2,4-triazol-1-yl)propyl, 3-methylthiopropyl, 3-methanesulphinylpropyl or 3-methanesulphonylpropyl.

10. A compound of the general formula (1): 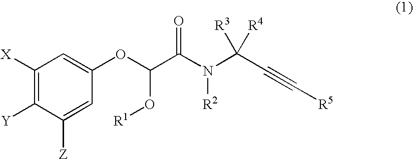
wherein
X, Y and Z are independently H, halogen, C₁₋₄ alkyl, halo(C₁₋₄)alkyl, C₂₋₄ alkenyl, halo(C₂₋₄)alkenyl, C₂₋₄ alkynyl, halo(C₂₋₄)alkynyl, C₁₋₄ alkoxy, halo(C₁₋₄)alkoxy, —S(O)ₙ(C₁₋₄)alkyl where n is 0, 1 or 2 and the alkyl group is optionally substituted with fluoro, —OSO₂(C₁₋₄)alkyl where the alkyl group is optionally substituted with fluoro, cyano, nitro, C₁₋₄ alkoxycarbonyl, —CONR′R″, —COR′, —NR′COR″ or —NR′COOR′″ where R′ and R″ are independently H or C₁₋₄ alkyl and R′″ is C₁₋₄ alkyl, provided that at least one of X and Z is other than H;
R¹ is a straight-chain C₁₋₄ alkyl group;
R² is H, C₁₋₄ alkyl, C₁₋₄ alkoxymethyl or benzyloxymethyl in which the phenyl ring of the benzyl moiety is optionally substituted with C₁₋₄ alkoxy;
R³ and R⁴ are independently H, C₁₋₃alkyl, C₂₋₃alkenyl or C₂₋₃ alkynyl provided that both are not H and that when both are other than H their combined total of carbon atoms does not exceed 4, or
R³ and R⁴ join with the carbon atom to which they are attached to form a 3 or 4 membered carbocyclic ring optionally containing one O, S or N atom and optionally substituted with halo or C₁₋₄ alkyl; and
R⁵ is H, C₁₋₄ alkyl or C₃₋₆ cycloalkyl in which the alkyl or cycloalkyl group is optionally substituted with halo, hydroxy, C₁₋₆ alkoxy, cyano, C₁₋₄ alkylcarbonyloxy, aminocarbonyloxy, mono- or di(C₁₋₄)alkylaminocarbonyloxy, —S(O)ₙ(C₁₋₆)alkyl where n is 0, 1 or 2, triazolyl, tri(C₁₋₄)-alkylsilyloxy, optionally substituted phenoxy, optionally substituted thienyloxy, optionally substituted benzyloxy or optionally substituted thienylmethoxy, or
R⁵ is optionally substituted phenyl, optionally substituted thienyl or optionally substituted benzyl,
in which the optionally substituted phenyl and thienyl rings of the R⁵ values are optionally substituted with one, two or three substituents selected from halo, hydroxy, mercapto, C₁₋₄ alkyl, C₂₋₄ alkenyl, C₂₋₄ alkynyl, C₁₋₄ alkoxy, C₂₋₄ alkenyloxy, C₂₋₄ alkynyloxy, halo(C₁₋₄)alkyl, halo(C₁₋₄)alkoxy, C₁₋₄ alkylthio, halo(C₁₋₄)alkylthio, hydroxy(C₁₋₄)alkyl, C₁₋₄ alkoxy(C₁₋₄)alkyl, C₃₋₆ cycloalkyl, C₃₋₆ cycloalkyl(C₁₋₄)alkyl, phenoxy, benzyloxy, benzoyloxy, cyano, isocyano, thiocyanato, isothiocyanato, nitro, —NR^{m}Rⁿ, —NHCOR^{m}, —NHCONR^{m}Rⁿ, —CONR^{m}Rⁿ, —SO₂R^{m}, —OSO₂R^{m}, —COR^{m}, —CR^{m}═NRⁿ or —N═CR^{m}Rⁿ, in which R^{m} and Rⁿ are independently hydrogen, C₁₋₄ alkyl, halo(C₁₋₄)alkyl, C₁₋₄ alkoxy, halo(C₁₋₄)alkoxy, C₁₋₄ alkylthio, C₃₋₆ cycloalkyl, C₃₋₆ cycloalkyl(C₁₋₄)alkyl, phenyl or benzyl, the phenyl and benzyl groups being optionally substituted with halogen, C₁₋₄ alkyl or C₁₋₄ alkoxy;
provided that R⁵ is not H when (i) X, Z, R¹, R³ and R⁴ are all methyl and Y, and R² are both H, (ii) X, Z, R³ and R⁴ are all methyl, Y is chloro, R¹ is ethyl and R² is H, (iii) X and Z are both chloro, R¹ is methyl or ethyl, R³ and R⁴ are both methyl and Y and R² are both H, (iv) X, Y and Z are all chloro, R¹, R³ and R⁴ are all methyl and R² is H, and (v) Y is chloro, Z is trifluoromethyl, R¹, R³ and R⁴ are all methyl and X and R² are both H.

11. A compound of the general formula (1): 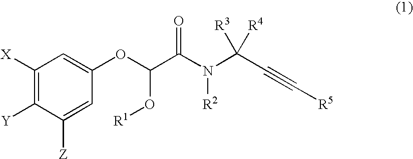
wherein
X, Y and Z are independently H, fluoro, bromo, iodo, C₂₋₄ alkyl, halo(C₁₋₄)alkyl, C₂₋₄ alkenyl, halo(C₂₋₄)alkenyl, C₂₋₄ alkynyl, halo(C₂₋₄)alkynyl, C₁₋₄ alkoxy, halo(C₁₋₄)alkoxy, —S(O)ₙ(C₁₋₄)alkyl where n is 0, 1 or 2 and the alkyl group is optionally substituted with fluoro, —OSO₂(C₁₋₄)alkyl where the alkyl group is optionally substituted with fluoro, cyano, nitro, C₁₋₄ alkoxycarbonyl, —CONR′R″, —COR′, —NR′COR″ or —NR′COOR′″ where R′ and R″ are independently H or C₁₋₄ alkyl and R′″ is C₁₋₄ alkyl, provided that at least one of X and Z is other than H;
R¹ is a straight-chain C₁₋₄ alkyl group;
R² is H, C₁₋₄ alkyl, C₁₋₄ alkoxymethyl or benzyloxymethyl in which the phenyl ring of the benzyl moiety is optionally substituted with C₁₋₄ alkoxy;
R³ and R⁴ are independently H, C₁₋₃ alkyl, C₂₋₃ alkenyl or C₂₋₃ alkynyl provided that both are not H and that when both are other than H their combined total of carbon atoms does not exceed 4, or
R³ and R⁴ join with the carbon atom to which they are attached to form a 3 or 4 membered carbocyclic ring optionally containing one O, S or N atom and optionally substituted with halo or C₁₋₄ alkyl; and
R⁵ is H, C₁₋₄ alkyl or C₃₋₆ cycloalkyl in which the alkyl or cycloalkyl group is optionally substituted with halo, hydroxy, C₁₋₆ alkoxy, cyano, C₁₋₄ alkylcarbonyloxy, aminocarbonyloxy, mono- or di(C₁₋₄)alkylaminocarbonyloxy, —S(O)ₙ(C₁₋₆)alkyl where n is 0, 1 or 2, triazolyl (e.g. 1,2,4-triazol-1-yl), tri(C₁₋₄)-alkylsilyloxy, optionally substituted phenoxy, optionally substituted thienyloxy, optionally substituted benzyloxy or optionally substituted thienylmethoxy, or R⁵ is optionally substituted phenyl, optionally substituted thienyl or optionally substituted benzyl,
in which the optionally substituted phenyl and thienyl rings of the R⁵ values are optionally substituted with one, two or three substituents selected from halo, hydroxy, mercapto, C₁₋₄ alkyl, C₂₋₄ alkenyl, C₂₋₄ alkynyl, C₁₋₄ alkoxy, C₂₋₄ alkenyloxy, C₂₋₄ alkynyloxy, halo(C₁₋₄)alkyl, halo(C₁₋₄)alkoxy, C₁₋₄ alkylthio, halo(C₁₋₄)alkylthio, hydroxy(C₁₋₄)alkyl, C₁₋₄alkoxy(C₁₋₄)alkyl, C₃₋₆ cycloalkyl, C₃₋₆ cycloalkyl(C₁₋₄)alkyl, phenoxy, benzyloxy, benzoyloxy, cyano, isocyano, thiocyanato, isothiocyanato, nitro, —NR^{m}Rⁿ, —NHCOR^{m}, —NHCONR^{m}Rⁿ, —CONR^{m}Rⁿ, —SO₂R^{m}, —OSO₂R^{m}, —COR^{m}, —CR^{m}═NRⁿ or —N═CR^{m}Rⁿ, in which R^{m} and Rⁿ are independently hydrogen, C₁₋₄ alkyl, halo(C₁₋₄)alkyl, C₁₋₄ alkoxy, halo(C₁₋₄)alkoxy, C₁₋₄ alkylthio, C₃₋₆ cycloalkyl, C₃₋₆ cycloalkyl(C₁₋₄)alkyl, phenyl or benzyl, the phenyl and benzyl groups being optionally substituted with halogen, C₁₋₄ alkyl or C₁₋₄ alkoxy.

12. A compound of the general formula (1): 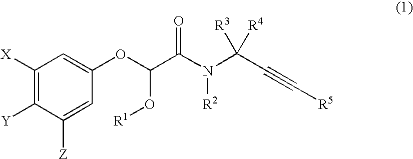
wherein
X, Y and Z are independently H, halogen, C₁₋₄ alkyl, halo(C₁₋₄)alkyl, C₂₋₄ alkenyl, halo(C₂₋₄)alkenyl, C₂₋₄ alkynyl, halo(C₂₋₄)alkynyl, C₁₋₄ alkoxy, halo(C₁₋₄)alkoxy, —S(O)ₙ(C₁₋₄)alkyl where n is 0, 1 or 2 and the alkyl group is optionally substituted with fluoro, —OSO₂(C₁₋₄)alkyl where the alkyl group is optionally substituted with fluoro, cyano, nitro, C₁₋₄ alkoxycarbonyl, —CONR′R″, —COR′, —NR′COR″ or —NR′COOR′″ where R′ and R″ are independently H or C₁₋₄ alkyl and R′″ is C₁₋₄ alkyl, provided that at least one of X and Z is other than H;
R¹ is a straight-chain C₁₋₄ alkyl group;
R² is H, C₁₋₄ alkyl, C₁₋₄ alkoxymethyl or benzyloxymethyl in which the phenyl ring of the benzyl moiety is optionally substituted with C₁₋₄ alkoxy;
R³ and R⁴ are independently H, C₁₋₃ alkyl, C₂₋₃ alkenyl or C₂₋₃ alkynyl provided that both are not H and that when both are other than H their combined total of carbon atoms does not exceed 4, or
R³ and R⁴ join with the carbon atom to which they are attached to form a 3 or 4 membered carbocyclic ring optionally containing one O, S or N atom and optionally substituted with halo or C₁₋₄ alkyl; and
R⁵ is C₁₋₄ alkyl or C₃₋₆ cycloalkyl in which the alkyl or cycloalkyl group is optionally substituted with halo, hydroxy, C₁₋₆ alkoxy, cyano, C₁₋₄ alkylcarbonyloxy, aminocarbonyloxy, mono- or di(C₁₋₄)alkylaminocarbonyloxy, —S(O)ₙ(C₁₋₆)alkyl where n is 0, 1 or 2, triazolyl (e.g. 1,2,4-triazol-1-yl), tri(C₁₋₄)-alkylsilyloxy, optionally substituted phenoxy, optionally substituted thienyloxy, optionally substituted benzyloxy or optionally substituted thienylmethoxy, or R⁵ is optionally substituted phenyl, optionally substituted thienyl or optionally substituted benzyl,
in which the optionally substituted phenyl and thienyl rings of the R⁵ values are optionally substituted with one, two or three substituents selected from halo, hydroxy, mercapto, C₁₋₄ alkyl, C₂₋₄ alkenyl, C₂₋₄ alkynyl, C₁₋₄ alkoxy, C₂₋₄ alkenyloxy, C₂₋₄ alkynyloxy, halo(C₁_{₋}₄)alkyl, halo(C₁₋₄)alkoxy, C₁₋₄ alkylthio, halo(C₁₋₄)alkylthio, hydroxy(C₁₋₄)alkyl, C₁₋₄alkoxy(C₁₋₄)alkyl, C₃₋₆ cycloalkyl, C₃₋₆ cycloalkyl(C₁₋₄)alkyl, phenoxy, benzyloxy, benzoyloxy, cyano, isocyano, thiocyanato, isothiocyanato, nitro, —NR^{m}Rⁿ, —NHCOR^{m}, —NHCONR^{m}Rⁿ, —CONR^{m}Rⁿ, —SO₂R^{m}, —OSO₂R^{m}, —COR^{m}, —CR^{m}═NRⁿ or —N═CR^{m}Rⁿ, in which R^{m} and Rⁿ are independently hydrogen, C₁₋₄ alkyl, halo(C₁₋₄)alkyl, C₁₋₄ alkoxy, halo(C₁₋₄)alkoxy, C₁₋₄ alkylthio, C₃₋₆ cycloalkyl, C₃₋₆ cycloalkyl(C₁₋₄)alkyl, phenyl or benzyl, the phenyl and benzyl groups being optionally substituted with halogen, C₁₋₄ alkyl or C₁₋₄ alkoxy.

13. A compound according to claim 10 wherein X, Y and Z are all chloro or methyl, or X and Z are both chloro or bromo and Y is H or methyl, or X and Z are both methyl or methoxy and Y is H, chloro, bromo or alkylthio, or X is methoxy, Y is H and Z is cyano or chloro, or X is methyl, Y is H and Z is ethyl, or X is chloro, bromo or trifluoromethyl and both Y and Z are H; R¹ is methyl, ethyl, n-propyl or n-butyl; R² is H; R³ and R⁴ are both methyl; and R⁵ is methyl, hydroxymethyl, methoxymethyl, 1-methoxyethyl, tert-butyldimethylsilyloxymethyl, 3-cyanopropyl, 3-(1,2,4-triazol-1-yl)propyl, 3-methylthiopropyl, 3-methanesulphinylpropyl or 3-methanesulphonylpropyl.

14. A process for preparing a compound of the general formula (1) as defined in claim 1 as herein described.

15. A fungicidal composition comprising a fungicidally effective amount of a compound of the general formula (1) as defined in claim 1 and a suitable carrier or diluent therefor.

16. A method of combating or controlling phytopathogenic fungi which comprises applying a fungicidally effective amount of a compound of the general formula (1) as defined in claim 1 to a plant, to a seed of a plant, to the locus of the plant or seed or to soil or any other plant growth medium.

17. A compound according to claim 12 wherein X, Y and Z are all chloro or methyl, or X and Z are both chloro or bromo and Y is H or methyl, or X and Z are both methyl or methoxy and Y is H, chloro, bromo or alkylthio, or X is methoxy, Y is H and Z is cyano or chloro, or X is methyl, Y is H and Z is ethyl, or X is chloro, bromo or trifluoromethyl and both Y and Z are H; R¹ is methyl, ethyl, n-propyl or n-butyl; R² is H; R³ and R⁴ are both methyl; and R⁵ is methyl, hydroxymethyl, methoxymethyl, 1-methoxyethyl, tert-butyldimethylsilyloxymethyl, 3-cyanopropyl, 3-(1,2,4-triazol-1-yl)propyl, 3-methylthiopropyl, 3-methanesulphinylpropyl or 3-methanesulphonylpropyl.

18. A method of combating or controlling phytopathogenic fungi which comprises applying a fungicidally effective amount of a composition according to claim 15 to a plant, to a seed of a plant, to the locus of the plant or seed or to soil or any other plant growth medium.
